(19) United States
(12) Patent Application Publication
(10) Pub. No.: US 2026/0117609 A1
(43) Pub. Date: Apr. 30, 2026

(54) DOWNHOLE FLUID SEPARATION FOR DRILLING A WELL IN A HOT SUBTERRANEAN ZONE

(71) Applicant: Eavor Technologies Inc., Calgary (CA)

(72) Inventors: Christian Besoiu, Calgary (CA); Matthew Toews, Calgary (CA); Aleksandr Vetsak, Calgary (CA)

(21) Appl. No.: 19/482,661

(22) PCT Filed: Apr. 13, 2024
(86) PCT No.: PCT/IB2024/053641

§ 371 Date: Nov. 7, 2025

Related U.S. Application Data
(60) Provisional application No. 63/500,835, filed on May 8, 2023.

(51) Int. Cl. E21B 21/00; E21B 21/08; E21B 36/00

(52) U.S. Cl. CPC E21B 21/002; E21B 21/08; E21B 36/001

(57) ABSTRACT

A wellbore is drilled in a subterranean zone with a drill bit of a drilling string. The drilling string includes tubing and a fluid separator uphole of the drill bit. While drilling, a drilling fluid is flowed through an interior of the drilling string and through the fluid separator. The fluid separator separates, from the drilling fluid, a fluid stream having a higher water-to-oil ratio than a remainder of the drilling fluid Uphole of the drill bit, the fluid stream is diverted from the fluid separator to an annulus around the exterior of the drilling string based on a specified temperature of a drilling string component while the remainder of the drilling fluid flows from the fluid separator to the drill bit.

### CROSS-REFERENCE TO RELATED APPLICATION

The present application claims the filing date benefit under 35 U.S.C. § 119 of U.S. Provisional Patent Application No. 63/500,835, filed May 8, 2023, entitled “Temperature Control for Well Drilling.” The entire contents of such application is hereby incorporated by reference in its entirety.

### TECHNICAL FIELD

This disclosure relates to drilling in hot subterranean zones, such as needed when drilling a geothermal well or other well in a hot zone.

### BACKGROUND

The high temperatures of hot subterranean zones make constructing the wells in the hot zones difficult. Tubing, drill bits, and other components of a drill string may have maximum temperatures or temperature ranges above which system performance degrades or is otherwise sub-optimal. Although drilling fluid flowing downhole through the drill string can cool drill bits and other bottomhole assembly components to within such specified temperatures, drilling fluid flowing back uphole via the annulus may have limited remaining heat capacity such that the cooling effect of the drilling fluid on the exterior of the tubing string (or of other components uphole of the bottomhole assembly exposed to the annulus) may be insufficient to cool the tubing or other annulus-exposed components to within their specified temperature ranges. This problem may be exacerbated by the use of insulated tubing (which, while desirable for purposes of cooling of the bottomhole assembly, reduces heat exchange between the interior of the tubing and the annulus) and by use of oil-rich drilling fluids that may otherwise be desirable for optimal performance of drilling bits (including, for example, contactless drilling bits).

### SUMMARY

This disclosure relates to drilling in hot subterranean zones, such as needed when drilling a geothermal well or other well in a hot zone.

In an aspect, a method includes drilling, with a drill bit of a drilling string, a wellbore in a subterranean zone. The drilling string includes tubing and a fluid separator uphole of the drill bit. The method further includes, while drilling, flowing a drilling fluid through an interior of the drilling string and through the fluid separator. The fluid separator separates, from the drilling fluid, a fluid stream having a higher water-to-oil ratio than a remainder of the drilling fluid. The method further includes diverting, uphole of the drill bit, the fluid stream from the fluid separator to an annulus around the exterior of the drilling string based on a specified temperature of a drilling string component while the remainder of the drilling fluid flows from the fluid separator to the drill bit.

In an aspect, a system includes a drilling string. The drilling string includes a tubing, a drill bit, and a fluid separator. The fluid separator is positioned in the drilling string to be uphole of the drill bit, and is configured to separate, from a drilling fluid flowed through an interior of the drilling string, a fluid stream having a higher water to oil ratio than the drilling fluid. The drilling string is configured to divert the fluid stream to an annulus around the exterior of the drilling string based on a specified temperature of a drilling string component while a remainder of the drilling fluid flows from the fluid separator to the drill bit.

The aspects above can include one, some or none of the following aspects. In certain instances, the drilling string component uphole of the separator is the tubing. In certain instances, the tubing is or includes coiled tubing. In certain instances, the coiled tubing includes or is a polymer tubing. In certain instances, the tubing is or includes insulated drill pipe. In certain instances, the drilling fluid is an oil-water emulsion. Certain instances include receiving, at a terranean surface, a return flow from the annulus, the return flow comprising a mixture of the fluid stream and the remainder, separating, at the terranean surface, the mixture into a water-rich surface stream and an oil-rich surface stream, and mixing, at the terranean surface, the water-rich surface stream and the oil-rich surface stream to form a mixture based on a target separation performance of the fluid separator, and flowing the loose-emulsion mixture into the drilling string. In certain instances, the specified temperature is an operational temperature range. Certain instances include diverting, by a diverter uphole of the separator, a portion of the drilling fluid from the drilling string into the annulus. In certain instances, the drill bit is a contactless drilling bit.

Other features and aspects are described below.

### BRIEF DESCRIPTION OF DRAWINGS

FIG. 1A is a schematic side cross-sectional view of an example closed loop geothermal system in accordance with the concepts herein.

FIG. 1B is a schematic side cross-sectional view of another example closed loop geothermal system in accordance with the concepts herein.

FIG. 2A is a detail view of an example bottom hole assembly of a drilling string for use in drilling a geothermal well, including those in the systems of FIGS. 1A and 1B, in accordance with the concepts herein.

FIG. 2B is a side view of an example geothermal well, such as those in the systems of FIGS. 1A and 1B, being drilled on jointed tubing in accordance with the concepts herein.

FIG. 2C is a side view of an example geothermal well, such as those in the systems of FIGS. 1A and 1B, being drilled on coiled tubing in accordance with the concepts herein.

FIG. 3A is a half cross-sectional view of an example of two joints of insulated tubing in accordance with the concepts herein.

FIG. 3B is a half cross-sectional view of another example of two joints of insulated tubing in accordance with the concepts herein.

FIG. 3C is a half cross-sectional view of another example of two joints of insulated tubing in accordance with the concepts herein.

FIG. 3D is a half cross-sectional view of an example of insulated coiled tubing in accordance with the concepts herein.

FIG. 3E is an end cross-sectional view of an example insulated tubing having an umbilical routed through an interior of the tubing.

FIG. 3F is an end cross-section view of an example insulated tubing having a layer of conductors defining an umbilical between other layers of the tubing.

FIG. 4 is a schematic view of a drilling string with a downhole separator in accordance with the concepts herein.

FIG. 5 is a schematic view of a downhole separator as a component of a drilling string, in accordance with the concepts herein.

FIG. 6 is a schematic view of another example of a downhole separator as a component of a drilling string, in accordance with the concepts herein.

FIG. 7 is a schematic view of a surface separation and re-mixing system in accordance with the concepts herein.

FIGS. 8A and 8B are end cross-sectional views of two examples of bundled coiled tubing in accordance with the concepts herein.

FIGS. 9A and 9B are end cross-sectional, perspective views of a bundled coiled tubing showing flow through the bundled tubings in accordance with the concepts herein.

FIGS. 10A-10C are schematic views of a method for drilling a wellbore in a subterranean zone to a target measured depth using a drill string with varying thermal resistance along its length in accordance with the concepts herein.

FIG. 11 is a representative temperature profile of the drilling operations shown in FIGS. 10A-10C in accordance with the concepts herein.

FIG. 12 is a process flow diagram of a method which can be implemented with the system described in reference to FIGS. 10A-10C.

Like reference numbers in the drawings represent like elements.

### DETAILED DESCRIPTION

In drilling a well in a hot zone, such as geothermal wells and other well types, thermal control techniques can be selectively implemented to mitigate heat transfer from the Earth into the drilling fluid. The thermal control techniques can help control the temperature of the drilling fluid, which is used to cool the tools of the bottom hole assembly and to shock cool the rock face being drilled, improving the rate of penetration. The selection and implementation of these techniques can be based on, among other things, achieving drilling fluid temperatures in the drilling string that can maintain the tools of the bottom hole assembly below their maximum rated temperatures. The selection and implementation of the techniques can also be based on the operational life/temperature relationship and performance/temperature relationship of the tools. For example, the techniques can be applied to target specified target operating temperatures and/or target operating temperature ranges, below the maximum rated temperature of the tools, to achieve specified tool life or tool performance objectives. Furthermore, the techniques can be applied to improve rate of penetration via shock cooling. More detail on both the thermal control techniques and how they are applied is provided below.

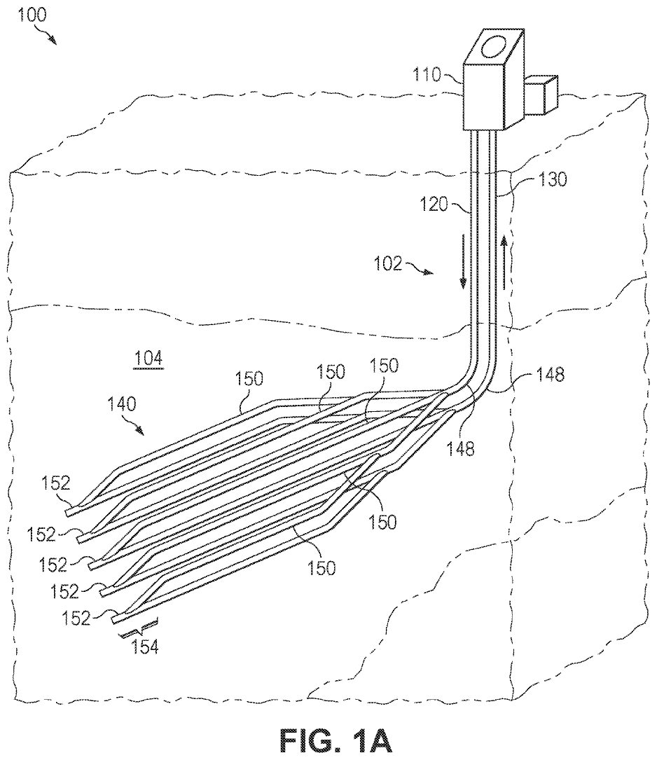

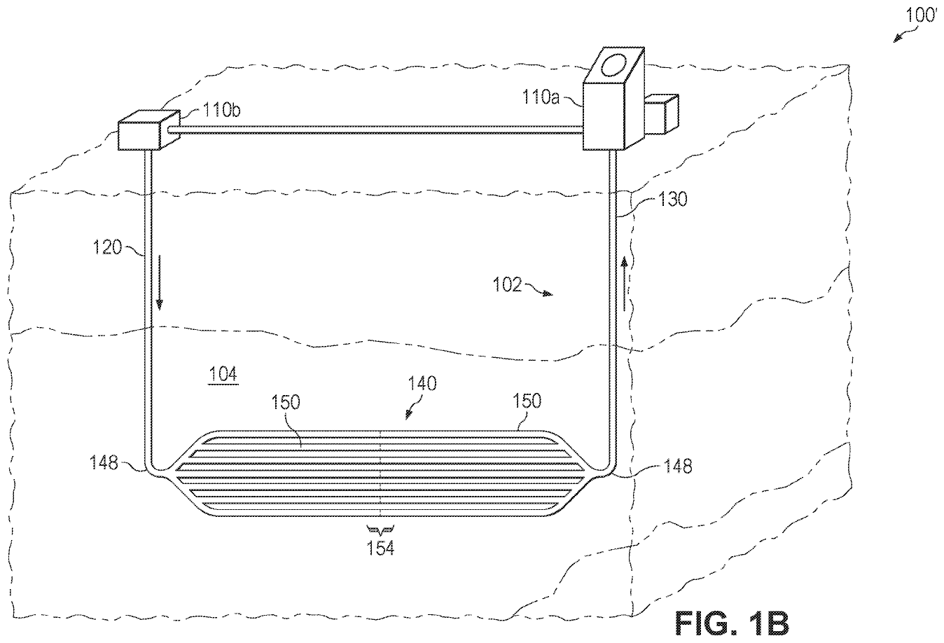

Turning now to FIG. 1A, an example closed loop geothermal system 100 is shown in schematic, side cross-sectional view in accordance with the concepts herein. In certain instances, the closed loop geothermal wellbore system can be, for example, a system such as that developed by Eavor Technologies Inc. of Calgary, Alberta, which includes a network of sealed lateral (e.g., horizontal, sloped or otherwise deviated) wellbores that exchange heat with the subterranean zone.

System 100 includes a geothermal well 102 drilled into the Earth through a geothermal subterranean zone of interest 104. In certain instances, the subterranean zone is a dry, impermeable (matrix permeability of 0.1 millidarcy or less) formation, portion of formation or multiple formations having little to no naturally occurring recoverable fluids. In certain instances, the subterranean zone is in a crystalline basement formation. In certain instances, the rock of the subterranean zone is in a granitic formation (e.g., granite). In the illustrated instance, well 102 includes an inlet surface wellbore 120 and an outlet surface wellbore 130 in close proximity, each extending between the terranean surface and the subterranean zone 104. The inlet surface wellbore 120 and outlet surface wellbore 130 are connected within the subterranean zone 104 by one or more connecting wellbores 140. In the illustrated instance, connecting wellbores 140 define a multilateral pattern of wellbores, including a plurality of pairs of lateral wellbores 150, a subset of which are kicked off from the inlet wellbore 120 and a subset of which are kicked off from the outlet wellbore 130. The pairs of lateral wellbores 150 each intersect at a respective junction 154 at or near their respective toes. Thus, the inlet wellbore 120, outlet wellbore 130 and connecting wellbores 140 define a closed loop.

The inlet wellbore 120 and the outlet wellbore 130 can be drilled from the same drilling pad and/or reside on the same well site. In certain instances, the wellbores 120, 130 are drilled within 10, 25, 50 or 100 meters of one another. In other instances, the inlet surface wellbore 120 and the outlet surface wellbore 130 can be separated by a longer distance. For example, FIG. 1B, discussed in more detail below, shows a configuration where the surface wellbores 120, 130 and the connecting wellbores 140 define a U-shape configuration. In certain instances, the inlet surface wellbore 120 and the outlet surface wellbore 130, when the geothermal well 102 is configured as a U-shape, are drilled 3,000 meters or more apart.

In the illustrated instance, inlet surface wellbore 120 and outlet surface wellbore 130 are vertical wellbores, drilled substantially straight (i.e., without the use of directional drilling methods or equipment). In other instances, one or both of the surface wellbores are other than vertical (e.g., slanted) and/or may be drilled with the use of directional drilling techniques. The connecting wellbores 140 are drilled using directional drilling techniques through the surface wellbores 120, 130, and include a curve in their trajectory beginning at a kickoff 148 at surface wellbores 120, 130. Although shown as slanted downward, in some instances, some or all of the connecting wellbores are horizontal. In some instances, the connecting wellbores 140 follow the geological dip of the formation in the subterranean zone. In some instances, lateral wellbores 150 are anywhere from 2,000 meters to 10,000 meters or more in length and from 1,000 meters to 8,000 meters or more in depth from the surface.

FIG. 1A shows each pair of lateral wellbores 150 parallel to one another extending in the same direction (azimuth) from their respective surface wellbore 120, 130. The lateral wellbores 150 extending from the inlet surface wellbore 120 are shown above the lateral wellbores 150 extending from the outlet surface wellbore 130. In some instances, the upper lateral wellbores 150 are directly above their (and are, in some instances, directly above a respective one of the lower lateral wellbores 150. In FIG. 1A the upper lateral wellbores 150 each turn to intersect its adjacent lower lateral wellbore 150 pair at the junction 154 to connect the surface wellbores 120, 130. In other instances, one or more of the lower lateral wellbores 150 could intersect the upper lateral wellbores 150. Regardless, the configuration of connecting wellbores 140, one set atop the other defines a stacked wellbore pattern, with one sub-pattern of wellbores above and one sub-pattern of wellbores below. In certain instances, one or more additional sets of stacked patterns can be drilled from the surface wellbores 120, 130 at different depths (i.e., with different kickoffs 148). In FIG. 1A, the lower lateral wellbores 150 extend past and below the junction 154 to define a sump 152. The sump 152 provides a location for debris to accumulate outside of the flow path through the wellbores. In other instances, one or more of the upper lateral wellbores 150 could extend past the junction to define the sump 152.

FIG. 1B another embodiment of a geothermal well system 100′ having lateral wellbores 150 extending, respectively, from the inlet and outlet surface wellbores 120, 130 toward one another. The pairs of lateral wellbores 150, once intersected, together with the inlet and outlet wellbores 120, 130, define a generally U-shape. The configuration of connecting wellbores 140 defines a pattern of wellbores, in certain instances, in the same plane. In certain instances, one or more additional patterns of connecting wellbores can be drilled between the surface wellbores 120, 130 at different depths (i.e., with different kickoffs 148).

Referring to FIGS. 1A and 1B, collectively, in some instances, the surface wellbores 120, 130 are cased (at least partially or entirely), and the connecting wellbores 140, including the junctures at the kickoffs 148 are open hole (i.e., without casing or liner or a junction liner). In some instances, the connecting wellbores 140 can be at least partially lined (e.g., include a liner or casing in those portions where the subterranean zone 104 is fractured, susceptible to collapse, unconsolidated or otherwise needing a liner). The connecting wellbores 140, including the junctures to the inlet and outlet surface wellbores 120, 130 are sealed (entirely or substantially) with a sealant against exchange of fluids with the surrounding subterranean zone 104. The sealant is designed such that all or substantially all of the working fluid circulated through the well 102 during operation is recovered to the surface, and no or little naturally occurring fluids from the subterranean zone 104 are recovered. In other words, the resulting well 102 is closed loop. In certain instances, the sealant can be applied to the wellbores during drilling the connecting wellbores 140, e.g., included in the drilling fluid and/or supplied in fluid slugs distinct from the drilling fluid. Alternatively, or additionally, the sealant is applied after drilling and/or during operation of the well. In certain instances, the sealant can be included in the heat transfer working fluid and/or supplied in fluid slugs, distinct from the heat transfer working fluid.

In the illustrated instance, system 100 further includes a facility 110 disposed between inlet surface wellbore 120 and outlet surface wellbore 130. Well 102 can be sealed and a working fluid added to the closed loop and circulated in the system such that it absorbs heat from subterranean zone 104. In certain instances, facility 110 includes valves and pumps for controlling the flow of the working fluid through the well 102, as well as a heat exchanger for extracting the heat from the working fluid and conveying it into a related process, such as a Rankine cycle (e.g., Organic Rankine Cycle) or other heat cycle that generates electricity, a steam generation process for industrial, agricultural or residential use, or another process. In certain instances, instead of, or in addition to a heat exchanger, facility 110 directly uses the heated working fluid, such as by passing it through an expander (e.g., a turbine) that drives an electric generator or directly using the heat of the working fluid in an industrial, agricultural or residential process. In some instances, facility 110 is disposed at or near the Earth's surface; in other instances, facility 110 may be disposed partially or fully within a subsurface location. The facility 110 need not be housed in one location, and, for example as shown in FIG. 1B, it can be split between one or more discrete locations (shown as facility 110a, 110b) connected by piping.

In either instance, FIG. 1A or 1B, the geothermal well is constructed by drilling and, if cased, casing the inlet wellbore 120 and outlet wellbore 130. The connecting wellbores 140 are drilled as intersecting lateral wellbores 150 from the inlet wellbore 120 and the outlet wellbore 130. In particular, a connecting wellbore 140 is constructed as a lateral wellbore 150 beginning at the sidewall of the inlet wellbore 120, i.e., kicking off from the inlet wellbore 120, and a lateral wellbore 150 beginning at the sidewall of the outlet wellbore 130, i.e., kicking off from the outlet wellbore. The lateral wellbores 150 are drilled to intersect at a junction 154 to define a connecting wellbore 140. Additional connecting wellbores 140 can be drilled as lateral wellbores 150 kicking off from the inlet wellbore 120, outlet wellbore 130 and/or other of the connecting wellbores 140 (or lateral wellbore 150 that may become a connecting wellbore 140). The lateral wellbores 150 are drilled using directional drilling techniques with a drilling string extending from the terranean surface through the inlet wellbore 120 and outlet wellbore 130, respectively. In certain instances, a whipstock is used to kick off the lateral wellbores 150 from their respective surface wellbore 120, 130.

The drilling of the inlet and outlet wellbores 120, 130 and connecting wellbores 140 can be conducted sequentially with one drill rig and drilling string, or concurrently and, in some instances simultaneously, with the two drilling strings each operating to drill their respective lateral wellbore 150 at the same time. In some instances, the inlet wellbore 120, the outlet wellbore 130 and the connecting wellbores 140 are drilled with two drilling rigs, one atop the inlet wellbore 120 and one atop the outlet wellbore 130. In other instances, the wellbores are drilled with a single drilling rig configured to drill two wellbores at the same time (e.g., having two masts, two top drives and/or two rotary tables, etc.). In certain instances, such as when using coiled tubing, the drilling rig can be a coiled tubing rig. In certain instances, such as when constructing the drilling string from both jointed tubing and coiled tubing, the drilling rig can be a hybrid jointed tubing and coiled tubing rig. For example, such a rig can have jointed pipe handling capability and a drive (e.g., top drive, rotary table drive and/or another tubing drive), as well as a tubing spool handling capability and a continuous injector system, and be able to switch between the two as different types of tubing, jointed or coiled, are assembled into the drill string.

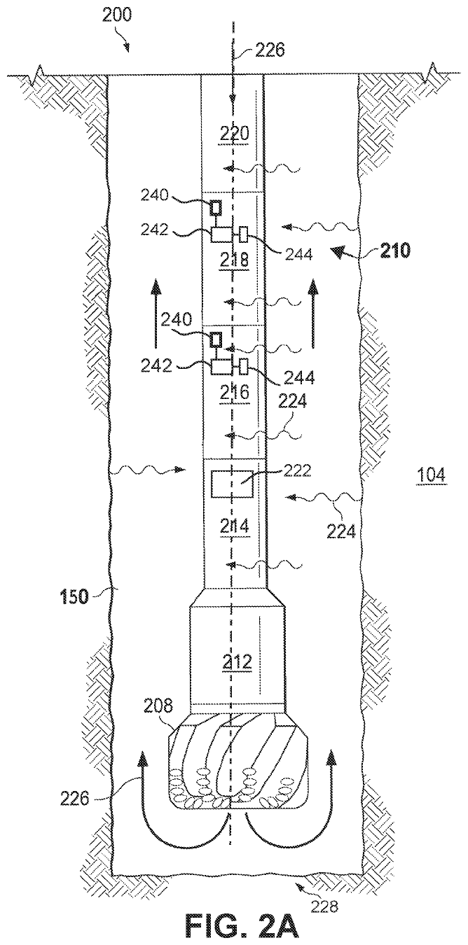

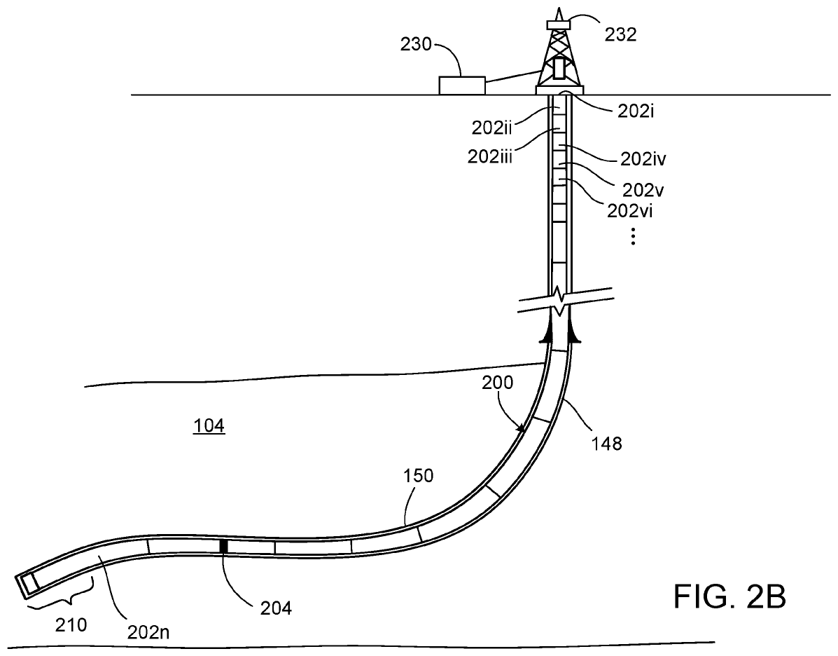

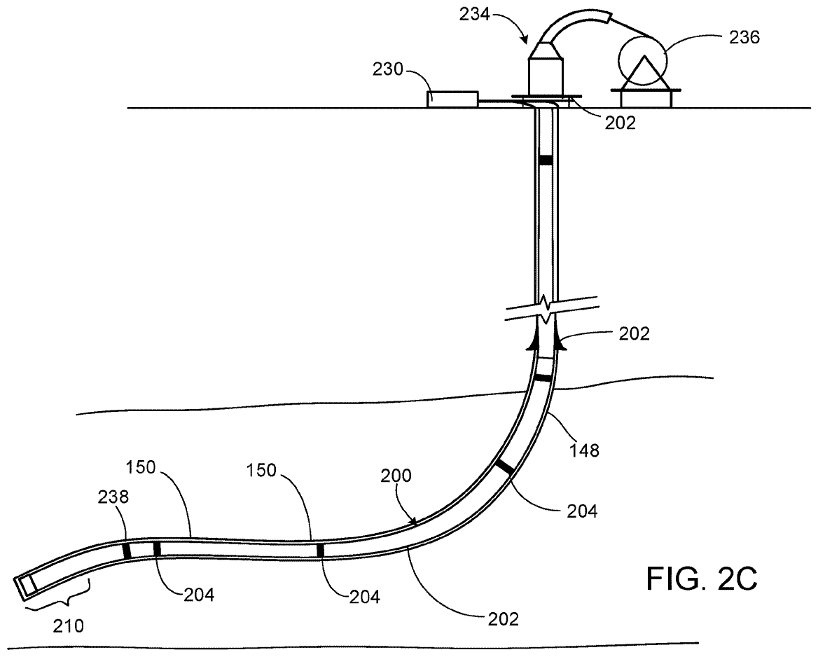

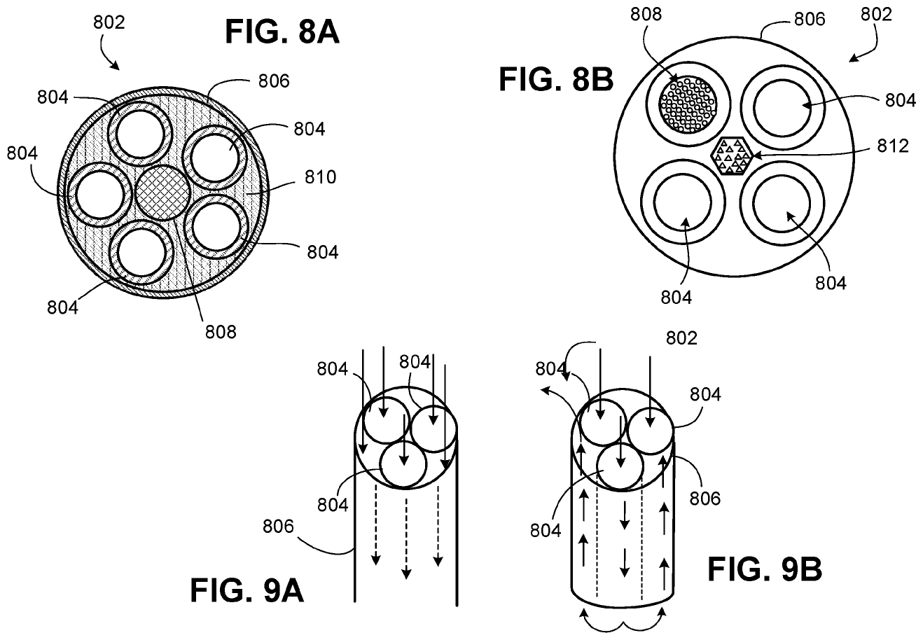

FIGS. 2A-2C show an example drilling string 200 that can be used for at least the directional drilling, i.e., drilling the connecting wellbores 140 and the lateral wellbores 150 that form them. Drilling string 200 of FIG. 2B is shown depending from a drilling rig 232 as multiple connected Joints of tubing 202 (individually referred to as 202i, 202ii . . . 202n), that may be drill pipe and/or another type of jointed tubing, with a bottom hole assembly (BHA) 210. In other instances, the drilling string 200 can be partially or wholly continuous coiled tubing 202. FIG. 2C shows a drilling string 200 constructed of multiple connected lengths of coiled tubing 202 in an upper interval and jointed tubing 202 with a BHA 210 in a lower, further downhole interval. Also, although FIG. 2C shows multiple tubings, in certain instances, the drilling string 200 can be a single, continuous length of coiled tubing depending from a coiled tubing rig 234 (or a hybrid rig) and having a BHA 210 or other components connected at its downhole end. Also, in certain instances, the drilling string 200 can be multiple side-by-side tubes, such as shown and discussed in more detail in connection with FIGS. 8-9.

The BHA 210 includes, among other things, a drill bit 208, a mud motor 212, a directional tool 214, one or more measurement subs 216, a ranging tool 218 and a communication tool 220 (e.g., a mud pulse telemetry, electric signaling, acoustic and/or other type of tool for sending communications to the terranean surface). The drilling string 200 can include other components, depicted as component 238 (FIG. 2C), such as fluid separators (discussed more below), tractors (to pull the string through the wellbore), agitator/vibrator tools (to reduce stiction of the string on the wellbore), mud turbine electric generators, battery systems, capacitors and/or other components, positioned in the BHA 210 or apart from the BHA 210. Although only one component 238 is shown, one or multiple could be provided in the configurations of FIGS. 2A-2C. Some or all of the tubing 202 can be insulated, having insulative features, such as insulative coatings or linings and/or multiple walls. In certain instances, some or all of the tubing has a length normalized, bulk, radial thermal resistance to heat transfer through a sidewall of the tubing that is at least 0.008 m K/W, at least 0.05 m K/W or higher. In certain instances, the drilling string 200 can include one or more actuable fluid diverters and/or separators 204 (i.e., bypasses) above the BHA 210, each separately actuable to divert at least a portion of the fluid flowing through the interior of the drilling string 200 into the annulus surrounding the drilling string 200.

The directional tool 214 is configured to selectively deflect the drill bit 208 towards the sidewall of the wellbore, and thus allows control over the drilling trajectory. In FIG. 2A, the directional tool 214 is shown as a rotary steerable type tool with actuable skids 222 that can be selectively extended into the sidewall of the wellbore to push the drill bit 208 toward a specified drilling trajectory. In other instances, the directional tool 214 can be a bent sub and/or other type of tool to control the trajectory of the drill bit 208. In certain instances, the directional tool 214 can be omitted, and the specified drilling trajectory can be achieved in another manner.

One or more measurement subs 216 can be provided (one shown). One example measurement sub 216 is a measurement while drilling (MWD) tool that measures, among other things, wellbore trajectory using one or more sensors (collectively sensor 240), such as a magnetometer sensor that senses the orientation of the tool (and thus the BHA 210) relative to the Earth's magnetic field and an accelerometer that senses the orientation of the tool relative to gravity. Another example measurement sub 216 is a logging while drilling (LWD) tool that measures, among other things, formation and casing properties with one or more sensors 240 such as a pressure sensor, an acoustic sensor, a gamma emitter/sensor and/or other sensors. Other types of measurement sub are within the concepts herein. In certain instances, a measurement sub 216 includes one or more processors (collectively processor 242) with one or more memories (collectively memory 244), where the memory 244 stores instructions to cause the processor 242 to generate, while the measurement sub 216 is downhole, values from raw sensor data. The calculated values determined by the processor 242, such as inclination, azimuth, density, porosity and/or other values, can be communicated to the terranean surface for use in guiding the directional drilling and/or for other purposes. Or, if the measurement sub 216 lacks the capability to generate values from the raw data, the raw data itself can be sent to the surface. In either instance, the communication can be made by the communication tool 220. The information transmitted by the measurement sub 216 can be communicated via wire (e.g., a wireline, an electrical or fiber line embedded in or coupled to the drilling string 200 and/or in another wired manner) and/or via mud pulse telemetry.

As a lateral wellbore 150 is being drilled, the ranging tool 218 is used to determine the location of the wellbore being drilled relative to other wellbores, including the lateral wellbores 150 (and connecting wellbores 140) that are being or that have already been drilled. In certain instances, the ranging tool 218 is a magnetic ranging tool that includes a highly sensitive magnetometer sensor 240 that operates to sense the magnetic field signal of a source in another wellbore, the source being a permanent or electromagnetic beacon, magnetically responsive materials (e.g., casing, drilling strings, tubing or other things made of steel or other magnetically responsive materials) and/or other sources. The ranging tool 218 can additionally or alternatively be an acoustic ranging tool that includes a highly sensitive acoustic sensor 240 (e.g., a geo phone or fiber optics based sensor) that operates to sense an acoustic signal of a source in another wellbore, where the acoustic signal is sound generated when drilling the other wellbore, a sound-generating device within a BHA in the other wellbore, or another acoustic source. In certain instances, the ranging tool 218 can additionally or alternatively be a resistivity ranging tool. From the sensor information, and other information (e.g., from additional sensors in the ranging tool 218 and/or the MWD/LWD tool), the relative direction of the source from the ranging tool 218 and the relative distance of the source from the ranging tool 218 can be determined.

In certain instances, the ranging tool 218 includes one or more processors (collectively processor 242) with one or more memories (collectively memory 244), where the memory 244 stores instructions to cause the processor 242 to generate, while the ranging tool 218 is downhole, the relative direction and distance values from raw sensor data, such as the sensor 240 output (e.g., the magnitude of the signal from the source) and other data (e.g., inclination, azimuth, and/or other raw data). The relative direction and distance values determined by the processor 242 while downhole can be communicated to the terranean surface and/or sent directly to the directional tool 214 for use in guiding the directional drilling. Or, if the tool 218 lacks the capability to generate direction and distance values, the raw data can be sent to the surface. In either instance, the communication to the surface can be made by the communication tool 220. The information transmitted by the ranging tool 218 can be communicated via wire (e.g., a wireline, an electrical or fiber line embedded in or coupled to the drilling string 200 and/or in another wired manner) and/or via mud pulse telemetry. Mud pulse telemetry is a more common, inexpensive manner of communicating data from downhole to the surface than by wire. But mud pulse telemetry is inherently very low bandwidth. Because the generated relative direction and distance values are a smaller amount of data than the raw data necessary to generate them, the relative direction and distance values can more readily be sent via mud pulse telemetry in a usable, practical time frame, than the larger amount of raw data. By comparison, sending the raw sensor data via mud pulse telemetry may take so long and delay the drilling such that use of the ranging data becomes impracticable or cost impracticable. Thus, by the ranging tool 218 generating downhole relative direction and distance to the source, no wire need be provided (e.g., no need for a wire in or on the drilling string 200 or the ranging tool 218 being deployed on wireline), and mud pulse telemetry can be used. In certain instances, the directional tool 214 can include a processor and memory configured to receive and use the relative direction and distance data generated by the ranging tool 218 for autonomously and/or semi-autonomously controlling the trajectory of the drilling.

In drilling a lateral wellbore 150, the ranging tool 218 is operated when needed to determine the ranging tool's 218 position, and thus the BHA 210 and current drilling position, relative to one or more sources in another or multiple lateral wellbores 150 or connecting wellbores 140. Such position information can be measured at specified regular or irregular intervals and used to ensure the lateral wellbore 150 being drilled is positioned in a specified manner relative to the other wellbore, e.g., in a specified trajectory (such as converging, diverging or parallel (precisely or substantially)) and at a specified distance or distances. As the lateral wellbore 150 approaches another lateral wellbore 150 to intersect the other lateral wellbore 150 (and create a connecting wellbore 140), the ranging tool 218 will be operated at shorter intervals to more precisely determine the location of the ranging tool 218 relative to the other lateral wellbore 150. The performance/temperature relationship of the ranging tool 218 may correlate the accuracy of the relative distance and/or the accuracy of the relative direction values that can be determined from the raw sensor 240 data, or the raw sensor 240, itself, to different temperatures of the ranging tool 218.

In certain instances, drilling bit 208 is a contact-type drilling bit, such as a polycrystalline diamond compact (PDC) drilling bit, rotary drilling bit, and/or another type of drilling bit that relies on the bit contacting the rock and mechanically transmitting force to load the rock face 228 (i.e., the end wall of the wellbore 150 at which rock is being removed) break the rock, and thus drill. In other instances, drilling bit 208 can be a contactless drilling bit configured to break the rock at the rock face 228 being drilled without requiring mechanical loading by contact between bit 208 and rock face 228. Examples of contactless drilling bits include bits for plasma drilling (such as the plasma drilling system developed by GA Drilling, A.S.), laser drilling (such as the laser drilling system developed by Foro Energy), microwave drilling (such as the microwave drilling system developed by Quaise, Inc.), thermal spallation drilling including supercritical water jetting or flame jets, electro-pulse drilling (such as the electro-pulse drilling systems developed by Tetra Corporation), and particle drilling (e.g., impacting the rock with particles entrained in fluid, such as the system developed by Particle Drilling Technologies, Inc.). Although, referred to as “contactless,” this descriptor is not meant to exclude systems where portions of a drilling bit may bump, brush against, or otherwise come into contact with the formation during the drilling process. For example, an electro-pulse drilling bit can still be considered a contactless drilling bit if the bit is configured to contact the rock such as to facilitate electrical transmission through the rock, because it does not rely on the bit contacting the rock and mechanically transmitting force to load the rock. In certain instances, drilling bit 208 is a hybrid contact/contactless bit configured both for contactless and contact drilling. One example of a hybrid drilling bit includes a bit body with the cutting components of a contactless drilling bit (e.g., electro-pulse drilling bit, plasma drilling bit, water or flame jet, and/or other type of contactless drilling) arranged to perform the preliminary drilling or primary drilling and the cutting components of contact-type drilling bit, such as an array of cutters (e.g., PDC cutters and/or other type of cutters), arranged around the perimeter of the bit for cleaning and/or reaming (widening) the wellbore drilled by the contactless portion of the bit. Other examples of hybrid drilling bits are within the concepts herein.

In electro-pulse drilling systems, an electrocrushing bit is utilized that has multiple electrodes that generate high energy sparks to break formation material and thereby enable it to be cleared from the path of the drilling assembly. The bit can generate multiple sparks per second using a specified excitation current profile that causes a transient spark to form and arc through the most conducting portion of the rock face at the downhole end of the wellbore. The arc causes that portion of the rock face penetrated by the arc to disintegrate or fragment and be swept away by the flow of drilling fluid. Furthermore, in certain instances, the direction and characteristics of the arc can be modulated to control the specified drilling trajectory, such as, for example, described in U.S. Pat. App. Pub. No. US20230144083A1. In certain instances, a highly electrically resistive drilling fluid is utilized for such electro-pulse drilling. In certain instances, electrically resistive drilling fluid is not needed for electro-pulse drilling, and the drilling fluid can include aqueous fluids. Descriptions of some electro-pulse drilling bits, drilling fluids, and related systems and methods that can be used herein are found in, for example, U.S. Pat. Nos. 4,741,405, 9,027,669, 9,279,322, 10,060,195, U.S. Pat. Pub. No. 12000299562A1, and PCT patent applications WO 2008/003092, WO 2010/027866, WO 2014/008483, WO 2018/136033, and WO 1200/236189. Because electro-pulse drilling and other forms of contactless drilling fails the rock in tension (as opposed to compression or shear), there can be a further synergistic effect with the cooling effects discussed in more detail below.

As a lateral wellbore 150 is being drilled, drilling fluid 226 is pumped down the internal bore of the drilling string 200 and out through the drill bit 208 to the rock face 228 being drilled. The flow of drilling exits the bit 208, and a portion of the flow impacts the rock face 228 being drilled (the then end wall of the incomplete lateral wellbore 150). The drilling fluid then flows uphole in the annulus between the drilling string 200 and the sidewall of the lateral wellbore 150 being drilled, and then uphole to the surface in the annulus between the drilling string 200 and the surface wellbore 120, 130. One purpose of the drilling fluid is to entrain cuttings from the rock face 228 and carry the cuttings to the terranean surface for removal from the wellbore. In certain instances, the drilling fluid can serve other purposes, such as to drive mud turbines to generate electricity and/or to at least partially buoy the drilling string 200, for example, in contactless drilling, where substantial weight on bit is not necessary for the drilling bit 208 to operate. Further, as discussed in more detail below, the drilling fluid 226 also cools the tools in the BHA 210 and cool the tubing 202 as the fluid flows through the bore of the drilling string 200 within the tools, and cools the rock face 228.

Each of the tools 212-220 and, in certain instances the tubing 202, in the drilling string 200 can have a minimum and/or maximum rated operating temperature the component is designed to endure while operating, which is typically specified by the manufacturer. For example, many high temperature tools have a maximum rated operating temperature of 150° C., 175° C. or 200° C. Certain constructions of tubing 202, such as polymer tubing (either entirely polymer or polymer reinforced with carbon, aramid, fiberglass, e-glass and/or other structural fiber), composite tubing (carbon fiber, aramid fiber, fiberglass, e-glass and/or other structural fiber), tubing with polymer insulation and/or other constructions, may have maximum rated operating temperatures in the same range. The drilling operations must maintain the tools and tubing below this maximum rated operating temperature or risk failure. Some high temperature tools optimized to operate in a high temperature environment may have a minimum rated operating temperature, below which the tool does not effectively operate or may fail. Some of the tools 208-220 and tubing 202 may each also have an operational life/temperature relationship where the tool's or tubing's operating life (e.g., reliability against failure) is different when exposed to different operating temperatures. Some of the tools 208-220 may also, or alternatively, have a performance/temperature relationship, where the tool's operating performance, e.g., efficiency, efficacy and/or accuracy, may be different when exposed to different operating temperatures. In other words, some of the tools 208-220 may have an efficiency/temperature relationship, efficacy/temperature relationship, and/or accuracy/temperature relationship where the relevant parameter is different for different temperatures. Similarly, certain constructions of tubing 202 may also have performance/temperature relationships, where the tubing's characteristics, such as tensile strength, elastic modulus, fatigue strength and/or other characteristics, may be different when exposed to different operating temperatures.

In certain instances, the tool and/or tubing have an operational life/temperature relationship with an increasing potential for operational failure with increasing temperature and/or with time at temperature despite being beneath the maximum rated operating temperature. In other words, the tool or tubing may have a yet lower operational failure rate when operated at or below certain temperatures beneath its maximum rated operating temperature and/or at or above certain lower temperatures. There may be certain minimum and/or maximum threshold temperatures (or time at temperatures) in that relationship where the potential failure rate increases markedly when the threshold is crossed and/or crossed for certain amounts of time. Were the operational life/temperature (or potential failure rate) graphed correlating temperature and operational life, the thresholds may be to inflection points in the curve. In certain instances, the performance/temperature relationship is such that the tool and/or tubing have a decreasing efficiency, efficacy, accuracy and/or other characteristics (e.g., tensile strength or elastic modulus of tubing) with increasing temperature even while staying beneath the maximum rated operating temperature. The performance/temperature relationship may also include certain minimum and maximum threshold temperatures in the relationship where the performance markedly changes (e.g., degrades) when the threshold is crossed and/or crossed for certain amounts of time. Were the performance/temperature relationship graphed correlating temperature and performance, the thresholds may be inflection points in the curve. The tool or tubing may be optimized to have a specified performance within a specified minimum and/or maximum temperature range, e.g., a rated operating temperature or temperature range that is typically specified by the manufacturer and is below the maximum rated operating temperature. Thus, specified maximum target and/or minimum temperatures or temperature ranges can be established based on the operational life/temperature and/or performance/temperature relationships and the drilling operations configured to maintain the tools and tubing at the specified target operating temperature or in temperature ranges. For example, the specified maximum target and/or minimum target temperatures or temperature ranges can be selected to achieve specified drilling objectives, including objectives such as achieving a specified length and/or duration of drilling run without tripping the drilling string 200 in/out of the wellbore, having a specified efficiency, efficacy, accuracy and/or other characteristics of tools in the BHA 210, the tubing 202, drilling cost, mean time between replacement/failure of components in the drilling string 200, and/or other aspects. In certain instances, the specified maximum target and/or minimum target temperatures or temperature ranges can be selected based on the thresholds/inflection points noted above, for example, to be at or near the threshold/inflection point on a favorable side of the threshold/inflection for the specified drilling objective.

In one example, the mud motor 212 is a positive displacement motor hydraulically driven by drilling fluid flow through a rotor and stator. The stator is typically made from an elastomer and the rotor is made of steel or another metal alloy. The different materials cause differential thermal expansion between the stator and rotor, which greatly impacts their “fit” to one another. If the fit is too loose, the motor efficiency decreases as drilling fluid is leaking between lobes of the stator/rotor, the motor's power drops off, and the motor supplies insufficient torque to the drill bit. If the fit is too tight, the motor can “chunk,” where the rotating rotor rips pieces of the stator off, and thus fails. Either situation can necessitate a costly, time consuming trip of the drilling string out of the well to replace the motor 212. Thus, the mud motor 212 has a specified minimum and maximum rated operating temperatures, i.e., a range, and this range is typically specified by the manufacturer. A motor configured for operation at 125° C., for example, may use different components, different materials and/or a different configuration (e.g., rotor/stator clearances) from a motor configured for operation at 175° C. Further, based on the motor's temperature/operating life relationship and performance/temperature relationship, one can specify a sub-range within the minimum and maximum rated operating temperatures at which the “fit” produces a specified efficiency (e.g., the highest efficiency or efficiency above a specified threshold), has a specified life (e.g., the longest life, life beyond a specified duration, life enough to complete a specified drilling target, such as drilling a certain measured depth or drilling one or more lateral wellbores in a single trip), or balance efficiency and life to a specified degree.

In addition to a maximum rated operating temperature, many sensor based tools, such as MWD and LWD of the measurement subs 216 and the ranging tool 218, have sensors that, even when operated below their maximum rated operating temperature, are more or less accurate as a function of temperature. This performance/temperature relationship can be expressed as a temperature/accuracy relationship. Magnetometers used in MWD and ranging tools to measure magnetic fields, are sensitive to temperature. In ranging tools the magnetometers must be highly accurate when effecting intersection of wellbores. Magnetometer accuracy is decreased by increasing temperature in both the signal-to-noise ratio and temperature drift. The same is also true of acoustic sensors used for acoustic ranging and the sensors used in LWD tools. Accuracy is improved by not only maintaining the sensors below the tool's maximum rated operating temperature in a region of the temperature/accuracy relationship with accuracy above a specified accuracy threshold (e.g., above a target or needed accuracy), but also maintaining the temperature within a minimum target and maximum temperature (i.e., within a target operating temperature range) on the temperature/accuracy relationship from measurement to measurement made by the tool to minimize the effect of temperature drift. Therefore, beyond maintaining the tools (and thus the sensors) below the maximum rated operating temperature, based on the tool's (or sensor's) temperature/operating life relationship and performance/temperature (accuracy) relationship, one can specify a sub-range within the minimum and maximum rated operating temperatures at which the sensor has a specified measurement accuracy (e.g., the highest accuracy or accuracy above a specified threshold), has a specified life (e.g., the longest life, life beyond a specified duration, life enough to survive drilling to a certain point or drilling one or more lateral wellbores in a single trip), or balance accuracy and life to a specified degree.

In another example, batteries (and tools having batteries) may have performance characteristics such as electrochemistry that is ineffective outside a certain temperature range or that is optimized to operate at a specified efficiency, e.g., a specified discharge efficiency, within a certain temperature range. In certain instances, batteries may experience different life, such as the number of charge/discharge cycles the battery may endure before failure may decrease, if outside a certain temperature range. Likewise, capacitor banks for contactless drilling may have a construction that is less efficient outside of a certain temperature range, that is optimized for a certain temperature range, or that may have a different life (e.g., charge/discharge cycles) outside a certain temperature range. Thus, manufacturers provide the batteries and capacitor banks with a minimum and maximum rated operating temperatures. In certain instances, some batteries can be viable from room temperature to −150° C., but high temperature batteries may only be viable between 100° C. and 185° C. Thus, above or below the end temperatures of the rated range, the battery may not operate and/or the efficiency drops off markedly as does the battery's life. Capacitors of capacitor banks may have similar operational characteristics. In certain instances, the performance can be different for different temperatures within the rated operating range, having different efficiency at different operating temperatures. Based on the battery's or capacitor's temperature/operating life relationship and performance/temperature relationship, one can specify a sub-range within the minimum and maximum rated operating temperatures at which the battery/capacitor has a specified discharge efficiency (e.g., the highest efficiency or efficiency above a specified threshold), has a specified life (e.g., the longest life, life beyond a specified duration, life enough to complete drilling to a certain point or drilling one or more lateral wellbores in a single trip), or balance efficiency and life to a specified degree.

In another example, permanent magnets used in ranging and other operations may loose magnetic strength when exposed to high temperatures, and the strength of the magnet may depend on temperature. Thus, manufacturers may specify maximum rated operating temperatures for the magnets beyond which the magnet's magnetic strength drops below a specified value represented by the manufacturer. Furthermore, the magnets may have a performance/temperature relationship whereby the magnetic strength decreases with increasing temperature above a specified temperature, while still being below the magnet's maximum rated operating temperature. Thus, in certain instances, the performance can be different for different temperatures within the rated maximum operating temperature, having different magnetic strength at different operating temperatures. Based on the magnet's performance/temperature relationship, one can specify a temperature below the maximum rated operating temperature at which the magnet has a specified strength (e.g., the highest efficiency or efficiency above a specified threshold), which can affect the range and/or accuracy of the tool using the magnet (e.g., the range and/or accuracy of a ranging tool 218 in determining the location of another wellbore).

In addition to maintaining the temperature of tools in the BHA 210 and/or tubing, in certain instances, the rock face (i.e., the end wall of the wellbore being drilled) ahead of the bit can be rapidly cooled to improve the rate of drilling (i.e., rate of penetration or ROP). This cooling, referred to herein as shock cooling, is effected when the difference between the inherent temperature of the rock (i.e., the temperature, but for the cooling effects of the drilling fluid, of the rock ahead of the drill bit that will immanently be drilled through) adjacent the rock face being drilled (i.e., the end wall) and the temperature of the drilling fluid at the rock face is at least 100° C. The temperature of the fluid at the rock face is the bulk fluid temperature where convective cooling of the rock face occurs, for example, within approximately 1 cm of the rock face being drilled. In certain instances, such temperature differential can be in geothermal environments where an inherent temperature of the rock at and inward from the rock face is at least 250° C. In certain instances, the temperature difference can be greater or less. In one example, the inherent temperature of the rock at and adjacent the rock face is at least about 500° C., the difference between the inherent temperature of the rock adjacent the rock face and the temperature of the drilling fluid at the rock face can be at least about 350° C. Such large temperature differences can increase ROP due the shock cooling effect, which causes the rock face to thermally contract. This thermal contraction stresses the rock in tension and reduces the effective confining pressure at the rock face. It can also create tensile microfractures within the rock matrix.

The ROP increase from shock cooling is the result of two mechanism—embrittlement of the rock face and thermally induced microstructure failure, such as microcracks, fractures, and displacement among and between rock grains due to differential thermal contraction. The drilling mud can be cooled to achieve one or both mechanisms. Regarding embrittlement, ductile rock transitions into a more brittle state when the temperature is decreased or pressure reduced. When a rapid thermal cooling treatment is applied to hot brittle rock, the internal temperature of the rock is lowered and the rock transitions into a more brittle state relative to the untreated rock. This zonal shift from ductile, semi brittle and any combination within the zone by temperature manipulation renders the treated rock embrittled relative to its initial untreated state. Rock strength (the stress required to cause irreversible deformation) does not necessarily change with an increase in brittleness. However, the deformation mode of a brittle rock is sudden failure and fracturing while for more ductile rock, the failure mode is to undergo more plastic deformation prior to failure. ROP generally increases with rock brittleness, regardless of drilling method. Note that the internal damage is a separate and additional effect in addition to the embrittlement mechanism discussed earlier. A higher cooling temperature differential is required to cause irreversible damage within the rock as opposed to simple embrittlement. The irreversible damage is manifested as microcracks, fractures, and displacement among and between rock grains due to differential thermal contraction. With sufficient thermal cooling both embrittlement and subsequent irreversible damage can be induced to the rock being drilled.

In certain instances, the difference between the inherent temperature of the rock adjacent the rock face and the temperature of the drilling fluid at the rock face is sufficient to lower the tensile strength of the rock and/or to damage the rock microstructure (which can reduce the rock strength due to small microfractures and weaknesses within the rock matrix) and/or induce spalling at the rock face due to thermal contraction of the rock. In some instances, the temperature difference is sufficient to reduce the confining pressure at the rock face (by thermally contracting the rock and inducing fractures). If thermal contraction occurs to the point where fractures are created in the rock face, it will lose confining pressure and become easier to break.

Referring briefly back to FIGS. 1A and 1B, the temperature of the rock increases with depth in the subterranean zone 104 as a function of the thermal gradient of the zone 104 (i.e., the temperature increase per unit depth). The connecting wellbores 140 are the deepest wellbores of the geothermal well 102, drilled in the hottest rock of the zone 104 targeted by the well. Because the connecting wellbores 140 extend horizontally or slope through this hottest part of the zone 104, and the connecting wellbores 140 (and the lateral wellbores 150 that form them) are long, often 1-5 km, 10 km or longer, the BHA 210 (FIGS. 2A-2C) must endure this hottest part of the zone 104 for long periods of time while drilling the connecting wellbores 140.

Referring to FIG. 2A, heat 224, illustrated by arrows, is transferred from the rock of the zone 104 into the uphole flowing drilling fluid 226 in the annulus, through the wall of the drilling string 200, to the downhole drilling fluid 226 in the bore drilling string 200. This heat transfer through the counter-current flow is the primary heating influence on the fluid flowing downhole in the drilling string 200. The greatest rate of heat transfer between the annulus fluid and the fluid in the drilling string 200 is nearer the terranean surface than the bottom of the wellbore, because the temperature differential between the fluid in the annulus and in the drilling string 200 is the greatest near the surface. The high temperature differential is due to relatively cooler fluid being constantly supplied at the top of the drilling string 200, and the fluid in the annulus nearer to the terranean surface having had a long resident time adjacent to the heat of the rock to heat up as it traverses from the bottom of the wellbore to the terranean surface. Conversely, the rate of heat transfer between the annulus fluid and the fluid in the drilling string 200 near the bottom of the drilling string 200 (near the BHA 210) is lowest, because the fluids have a lower temperature differential. This lower temperature differential is in part because the fluid in the annulus in this region was recently the fluid in the drilling string 200.

As described in more detail below, thermal control techniques can be selectively implemented, as needed, to provide a cool flow of the drilling fluid to cool the tools in the drilling string 200 to maintain the tools below their maximum rated operating temperature. These techniques can also be selectively implemented to cool the tools to specified temperature targets or specified target ranges (minimum/maximum temperatures) based on temperature dependent characteristics, such as the operational life/temperature relationship and the performance/temperature relationship of the tools. Furthermore, these techniques can also be selectively implemented to produce drilling fluid to shock cool the rock face 228 being drilled ahead of the bit 208 to improve the ROP. In certain instances, these thermal control techniques can cool the BHA 210 to at least 50° C. cooler than the rock temperature, and certain instances at least 150° C. cooler than rock temperature. When shock cooling, in certain instances, these thermal control techniques can produce drilling fluid released by the drill bit 208 onto the rock face 228 that is at least 100° C. cooler than the rock face 228 being drilled, and in certain instances, 350° C. or more cooler.

The thermal control techniques can include use of insulated tubing to control the bulk, radial thermal resistance to heat transfer (hereinafter “thermal resistance”) through the tubing into the drilling fluid flowing through the drilling string 200. Reducing the heat transfer with insulated tubing results in a reduction in the temperature of the fluid at the BHA 210 and in the temperature of the fluid supplied into the wellbore through the drill bit 208 to the rock face 228. The string 200, whether jointed tubing or coiled tubing, can be entirely insulated tubing or some of the tubing 202 can be insulated while other of the tubing 202 is not insulated. Different tubing 202 of different thermal resistance to heat transfer through the wall of the tubing (by different insulation, different construction and/or different tubing materials) can be arranged in different manners in the drilling string 200 to achieve a drilling string 200 with intervals of different thermal properties. Furthermore, as drilling progresses, the thermal resistance of the drilling string 200 can be changed by changing the amounts (and proportions) of tubing having different thermal resistances, e.g., uninsulated tubing, insulated tubing and tubing of differing insulation properties. The use of insulated tubing and the arrangement of insulated tubing in the drilling string 200 can be based on the maximum and/or minimum rated temperature of the BHA 210 tools and, in certain instances, specified target operating temperatures determined based on the life/temperature relationship and performance/temperature relationship of the tools, as well as temperatures for shock cooling.

In drilling a wellbore, a maximum drilling fluid temperature and/or a minimum drilling fluid temperature, both inside and outside of the drilling string 200, may be specified based on the temperature characteristics of the BHA 210 or tubing 202 and/or temperature needs for shock cooling the rock face 228. For example, the maximum drilling fluid temperature may be specified based on a fluid temperature needed to cool the tubing 202 and/or cool the BHA 210 to maintain the tubing and/or the BHA 210 tools at or below their maximum rated temperatures and/or a specified maximum target operating temperature for one or more tools and/or the tubing, as well as, in certain instances, based on the temperature of fluid exiting the drill bit 208 needed to achieve the desired degree of the shock cooling effect. The minimum drilling fluid temperature may be specified based on a minimum fluid temperature that will not cool the BHA 210 to below a minimum rated temperature and/or a specified minimum target operating temperature for one or more of its tools.

A drilling string 200 may not need insulated tubing to drill at shallow, cooler depths to maintain the fluid below the specified maximum drilling fluid temperature. Thus, a string 200 made entirely of insulated tubing 202 assembled toward having drilling fluid temperatures below a specified maximum fluid temperature at the end of the run (e.g., at the end of a lateral wellbore 150) may result in drilling fluid temperatures that are too cool, e.g., below a specified minimum fluid temperature, in shallower, cooler rock near the beginning of the run (e.g., when drilling the lateral wellbores 150 near the kickoff 148). As drilling progresses to hotter, deeper rock (e.g., the bulk of the lateral wellbores 150 to their end), and higher thermal resistance tubing is needed, a drilling string 200 assembled toward having drilling fluid temperatures above a specified minimum drilling fluid temperature while drilling at shallow, cooler depths may not have the needed thermal resistance to maintain the drilling fluid temperatures below the specified maximum fluid temperature. The arrangement, in the drilling string 200, of insulated tubing and/or insulated tubing among other uninsulated tubing in the drilling string 200 can be configured to achieve and maintain (alone or together with other techniques described below) drilling fluid temperatures at or below a specified maximum fluid temperature of over the course of a drilling run, while also maintaining at least a specified minimum temperature over the course of the drilling run. In other words, the arrangement of insulated tubing in the drilling string 200 can be configured to provide a degree of temperature uniformity over the course of a drilling run.

In certain instances, the drilling string 200 is initially assembled with a first interval adjacent the BHA 210 of uninsulated tubing or of insulated tubing have a first (low) thermal resistance while being used to drill shallower, cooler parts of the zone 104. Thereafter, insulated tubing, or insulated tubing with a second (higher than the first) thermal resistance, is added to the drilling string 200 in a second interval atop the first interval of tubing as the drilling progresses into deeper, hotter parts of the zone 104. The addition of higher thermal resistance tubing to the string 200 in the second interval progressively increases the overall thermal resistance to heat transfer of the drilling string 200 as the ratio of uninsulated to insulated (or low thermal resistance to higher thermal resistance) tubing increases. Moreover, the increase in thermal resistance is where it is needed most—near the surface, where the counter-current heat transfer is the greatest. In certain instances, by the end of a run (e.g., at the end of a drilled lateral wellbore 150) the length of the drilling string 200 is approximately 30%-15% uninsulated or having a first, low thermal resistance and approximately 70%-85% the second, higher thermal resistance. Other ratios, however, are viable and within the concepts herein.

By way of example, a drilling string 200 may be initially assembled with 50 joints of uninsulated tubing. As 50 more joints of insulated tubing are added, and the drilling progresses to deeper, hotter rock, the drilling string 200 evolves to 50% (ignoring the BHA) insulated. The drilling string 200 further evolves to 80% insulated with the addition of another 150 joints of insulated tubing as the drilling progresses to yet deeper, hotter rock. In other words, as the drilling progresses to deeper, hotter rock, and both the need for and the needed degree of the thermal resistance increases, so does the bulk thermal resistance of the drilling string 200. Moreover, this added thermal resistance is where it is most effective, at the top of the drilling string 200 where the counter-current heat transfer is the greatest. The same effect can be accomplished with a drilling string 200 constructed of coiled tubing, for example, by using a different spool of coiled tubing 202, having different thermal resistance, for each interval.

The drilling string 200 can also be configured by including three or more intervals of different thermal resistance. In one example, the string 200 may begin as uninsulated tubing or insulated tubing of a first thermal resistance in a first interval adjacent the BHA 210. As drilling progresses into deeper, hotter parts of the zone 104, insulated tubing having a higher, second thermal resistance than that in the first interval is added atop the first interval. Then, as drilling progresses into yet deeper, hotter parts of the zone 104, insulated tubing having a yet higher, third thermal resistance than that in the second and first intervals is added atop the second interval. The result, when the drilling has reached the end of the run, is a drilling string having three intervals of differing thermal resistance, with the highest thermal resistance being near the terranean surface where the highest counter-current heat transfer exists. In other instances, four or more intervals of differing thermal resistance can be provided in the drilling string 200.

Furthermore, the arrangement of insulated tubing 202 in the drilling string 200 can be configured with mechanical characteristics of the tubing and drilling string in mind. For example, the insulating material of the insulated tubing 202 can be fragile and can suffer greater wear and tear than tubing without such an insulating layer (or with a thinner insulating layer). Such wear and tear can be worse in deviated (sloped or horizontal), open-hole (as opposed to cased) wellbore sections and particularly in those portions of the drilling string 200 near the BHA 210. This is because the torsional vibrations due to the drilling can be greater near the BHA 210, abrasion force can be higher as the tubing lays on its side in the sloped or horizontal portions of the wellbore (as compared to the vertical portions), and the rock surface of the open hole in the lateral being drilled can be more abrasive (as compared to casing). Thus, uninsulated tubing or tubing with ruggedized insulation can be positioned near the BHA 210, where the wear and tear on the tubing is highest. In certain instances, wear or damage potential may dictate a larger interval of uninsulated tubing near the BHA 210 than would be ideal for temperature considerations. That larger interval of uninsulated tubing can be compensated for with yet higher thermal resistance in the second, or second and subsequent, intervals. In certain instances, the drilling string 200 may be assembled such that, over the course of a drilling run, the insulated tubing 202 is entirely or mostly in the inlet or outlet wellbore 120, 130 and uphole from the lateral wellbore 150 being drilled. As the inlet or outlet wellbores 120, 130 are vertical or at a shallower slant than the lateral wellbores 150, the drilling string 200 has a lighter contact with the wall of the wellbore and thus produces less contact wear on the insulated tubing 202. Furthermore, the inlet and outlet wellbores 120, 130 are typically cased, yielding yet less contact wear on the insulated tubing 202.

Thermal control techniques can also include controlling the drilling fluid flow rate, distribution, and drilling fluid properties to affect the heat transfer, and thus the temperature of the fluid. In certain instances, for example with water-based fluids, increasing the flow rate can reduce the temperature of the drilling fluid in part because cool fluid more quickly displaces heated fluid in the drilling string 200, in the wellbore around the bit 208, and in the annulus near the bottom of the wellbore (i.e., near and around the BHA 210). Selecting lower viscosity drilling fluids allow higher flow rates without excess heat generation from friction (hydraulic friction losses) that would otherwise occur at the higher flow rates. For example, in a primarily oil based drilling fluid (whether hydrocarbon or synthetic oil), having 90% oil, and with a low thermal resistance drilling string or an uninsulated drilling string, the frictional effect makes a lower flow rate typically better at cooling the BHA 210. Also, in these conditions, higher viscosity fluids, such as the 90% oil based fluids, are typically better at cooling the BHA 210 than lower viscosity fluids. However, if insulated or high thermal resistance tubing 202 is used, a lower viscosity fluid can be selected to allow the fluid to be flowed at a higher flow rate to improve cooling. This is counter to uninsulated tubing, where higher viscosity fluids are selected for their typically lower convective heat transfer coefficient needed to mitigate against heat transfer into the fluid in the drilling string. Thus, the drilling fluid flow rates can be selected based on the specified maximum and/or minimum drilling fluid temperatures, discussed above, which in turn are determined based on the maximum rated temperatures of the tools in the BHA 210, specified maximum target and/or minimum temperatures determined based on the life/temperature relationship and performance/temperature relationship of the tools, and/or temperatures for shock cooling.

Controlling the distribution of flow between the annulus and drilling string 200 can also affect heat transfer and can be adjusted by releasing flow from within the drilling string 200 into the annulus via a one or more fluid diverter tools 204. Three such diverter tools are shown in FIG. 2B; however, in some instances, a fewer or greater number of diverter tools (for example, only one diverter tool or five diverter tools) can be deployed as part of drilling string 200. For example, a diverter tool 204 above and near to the BHA 210 bypasses flow to the annulus, reducing the amount of fluid that flows to the BHA 210 and through the drill bit 208. The flow diverter tools 204 can allow higher flow rates in the upper portion of the drilling string 200 if the BHA 210 or overall well design would otherwise limit flow rate. In some instances, the greater fluid flow through the drilling string 200 above the diverter tool 204 results in a lower fluid temperature at the BHA 210 and exiting through the drill bit 208. The different flow diverters 204 and/or multiple flow diverters 204 can be configured to be actuated to bypass different amounts of fluid into the annulus at one or multiple locations to change (e.g., increase) the thermal mass of the fluid flowing through the string 200 to affect the fluid temperature (e.g., decrease) through the BHA 210, exiting the drill bit 208, and in the annulus uphole of BHA 210. The different flow diverters 204 and/or multiple flow diverters 204 can be configured to be actuated to bypass different amounts of fluid into the annulus at one or multiple locations to affect the temperature of the fluid in the annulus, for example, to cool the exterior of the tubing of the drilling string 200. In one example, the flow diverter tool 204 can be actuated to bypass 70% of the flow to the annulus, and direct the remaining flow through the BHA 210. The use of flow diverter tools 204 can also allow circulation of the drilling fluid when not drilling, to continue to maintain consistent fluid temperature by bypassing enough fluid into the annulus so that the fluid going to the mud motor (if provided) is not enough to turn the drill bit 208 or not enough to turn the drill bit 208 with enough torque to drill the rock. Thus, the number, the configuration of diverter tools 204 in the drilling string 200, and when the diverter tools 204 are actuated to divert fluid can be selected based on the specified maximum and/or minimum drilling fluid temperatures, discussed above, which in turn are determined based on the maximum rated temperatures of the tools in the BHA 210 and, in certain instances, the tubing 202 itself, specified maximum target and/or minimum target temperatures determined based on the life/temperature relationship and performance/temperature relationship of the tools and/or tubing, and/or temperatures for shock cooling.

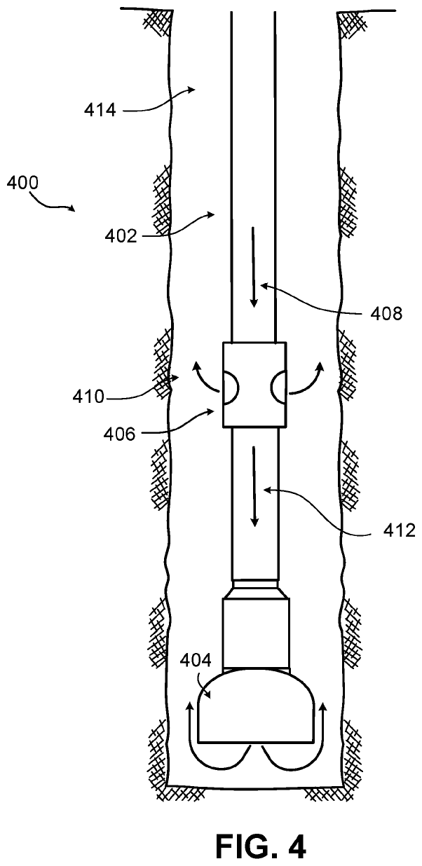

In some instances, instead of or in addition to diverter tools 204, the tool 204 can be a separator (FIG. 2C) configured to separate drilling fluid 226 into a water-rich stream and an oil-rich (hydrocarbon and/or synthetic oil) stream and divert the water-rich stream to the annulus uphole of BHA 210. One or multiple separators can be used, and the number, the configuration of separator tools in the drilling string 200, and, if actuable, when and to what degree the separator tools are actuated to separate and divert fluid can be selected based on the specified maximum and/or minimum drilling fluid temperatures, discussed above, which in turn are determined based on the maximum rated temperatures of the tools in the BHA 210 and, in certain instances, the tubing 202 itself, specified maximum target and/or minimum target temperatures determined based on the life/temperature relationship and performance/temperature relationship of the tools and/or tubing, and/or temperatures for shock cooling. Furthermore, by diverting a water-rich (and thus high heat-capacity) stream into the annulus, the stream better cools the exterior of tubing 202 (and/or of other components with which the annular fluid stream may in contact), while flowing a relatively oil-rich remaining stream to the drill bit for lubricity (for reducing torque and drag of the bit on the wellbore and/or lubricate rotating components of tools in the string), chemical stability, and dielectric properties (such as those needed with pulsed power drilling bits) at the drill bit. Thus, having separators of specified characteristics and/or actuable separators enables more control of the oil/water ratio of the drilling fluid, and over where those ratios are provided, than simply supplying fluids of a certain oil/water ratio from the surface. Further details regarding such separator components in certain instances is described below in reference to FIGS. 4-6.

The distribution of flow between the annulus and drilling string 200 can be controlled by releasing flow from within the drilling string 200 into the annulus from one or multiple tubes in the drilling string 200 that open to the annulus above the BHA 210. As described in more detail with respect to FIGS. 8-9, the drilling string 200 can have multiple tubes. One or more of the tubes are coupled to the drilling bit 208 for supplying drilling fluid to the BHA 210 and drilling bit 208, and one or more of the tubes can be open to the annulus and configured to release the fluid into the annulus at one or multiple locations along the length of the drilling string 200, much like the diverter tools 204 discussed above. Because these one or more tubes configured to release fluid into the annulus are separate from the tube or tubes supplying drilling fluid to the drill bit 208, they can supply the drilling fluid and/or one or more other fluids, e.g., cooling fluids, into the annulus. If multiple tubes are provided to supply fluid into the annulus, different fluids can be released into the annulus at different locations along the drilling string 200. Thus, the number, the configuration of multiple tubes in the drilling string 200, the fluids in each of the tubes, and where along the drilling string 200 the tubes introduce flow into the annulus can be selected based on the specified maximum and/or minimum fluid temperatures, discussed above, which in turn are determined based on the maximum rated temperatures of the tools in the BHA 210 and, in certain instances, the tubing 202 itself, specified maximum target and/or minimum target temperatures determined based on the life/temperature relationship and performance/temperature relationship of the tools and/or tubing, and/or temperatures for shock cooling.

Thermal control techniques can include selecting drilling fluid based on its thermal properties. Different drilling fluids can have different thermal properties, such as volumetric heat capacity and thermal conductivity. The different thermal properties thus affect the temperatures of the drilling fluid at the BHA 210, of drilling string components uphole of BHA 210 (including tubing 202), and in the wellbore, as well as the degree that the drilling fluid cools the tools of the BHA 210 and the rock face 228 (the relevance of cooling the rock face is discussed more below). For example, heat transfer through the drilling fluid decreases with decreasing thermal conductivity. Thus, the heat transfer from the rock of the zone 104 through to the drilling fluid in the interior of the drilling string 200 can be controlled, to some degree, by the drilling fluid selection (e.g., reducing heat transfer through the fluid by selecting fluid with a lower thermal conductivity and vice versa). The temperature rise of the drilling fluid for a given amount of heat transfer is lower for higher heat capacity. Thus, the cooling effect of the drilling fluid on the BHA 210, other drilling string components, including tubing 202, and the rock face 228 can be controlled, to some degree, by the drilling fluid selection (e.g., increasing the cooling on the BHA 210 by selecting fluid with a higher heat capacity and vice versa). As a component of drilling fluid, oil has certain advantages over water, including greater lubricity, greater efficiency in cuttings removal and hold flushing, and less reactivity with geological formations. Furthermore, as a drilling fluid component, the oil can act as a dielectric fluid necessary for certain contactless drilling applications. Water, by contrast, has a greater heat capacity and can therefore be advantageous for cooling downhole tubing and tools. Water can also be more rheologically stable at high temperatures than oil. Oil and water bases can be mixed in different ratios to achieve different thermal conductivity and heat capacity than purely water based or oil based drilling fluids. For example, in certain instances, the fluid may contain between 90% and 60% oil based fluid and the remainder water based fluid. Other constituents can be included in the drilling fluid to increase or decrease the heat capacity and/or thermal conductivity. By selecting oil based drilling fluids or water based drilling fluids, or different ratios of each, and/or by selecting constituents of the drilling fluids, the thermal properties of the drilling fluid can be adjusted.

In another example, a phase-change material such as water ice or dry ice can be added to the drilling fluid. The phase-change materials can absorb thermal energy as it undergoes a phase change (e.g., melts). In some instances, the phase-change materials can be configured so that the phase-change materials undergo a phase change proximate to the drilling bit 208 to centralize the cooling effect in the BHA 210 and in the fluid exiting the drill bit 208. For example, the characteristics of the phase change material and/or the flow rate of the drilling fluid can be controlled to control target location of the phase change.

Thus, the drilling fluid, itself, can be selected based on the specified maximum and/or minimum drilling fluid temperatures, discussed above, which in turn are determined based on the maximum rated temperatures of the tools in the BHA 210 and/or tubing, specified maximum target and/or minimum temperatures determined based on the life/temperature relationship and performance/temperature relationship of the tools and/or tubing, and/or temperatures for shock cooling.

Furthermore, different drilling fluids can be used for different intervals in a drilling run. For example, the drilling fluid for a first interval, nearer the terranean surface, may be different than the drilling fluid for a second interval, nearer the target depth of a lateral wellbore 150. In certain instances, the drilling fluid in the second interval may be selected prioritizing the thermal characteristics of the fluid to control the BHA 210 temperature and temperature of the fluid exiting the drill bit 208, while in the first interval, other aspects such as drilling performance, cost and/or other factors may be prioritized. Three, four or additional intervals, each have different fluids, can be implemented.

Another thermal control technique can include cooling the drilling fluid at the terranean surface, after exiting the annulus and prior to reinjection into the drilling string 200. The cooling decreases the temperature of the fluid entering the drilling string 200, which can reduce the temperature of the fluid at the BHA 210 and the temperature of the fluid supplied into the wellbore at the drill bit 208. The cooling can be accomplished via a cooler 230 (FIGS. 2B and 2C) that utilizes air or water cooling, refrigeration cycles, evaporative cooling, or any other type of cooling, and typically involves circulating the fluid through a heat exchanger of the cooler. However, with insulated tubing in the drilling string 200, one key advantage is the inlet temperature of the fluid is not as critical as in a drilling string 200 without insulated tubing. Thus, expensive and energy-hungry cooling with refrigeration cycles can be avoided or used sparingly with minimal impact to the BHA 210 circulating temperature. For example, in certain instances it is possible to cool the drilling fluid at surface to 38° C. and (together with other thermal control techniques) achieve the specified maximum target temperatures without using a refrigeration type cooler. Furthermore, different cooling can be applied during different intervals of the drilling (during the same or some of the same intervals as discussed in connection with the drilling fluid, or different intervals). For example, a first interval, nearer the terranean surface, may not utilize any cooling or may utilize a first degree of cooling, while a second interval, nearer the target depth of the lateral wellbore 150 may use cooling or a second, different degree of cooling (e.g., greater degree of cooling), the first interval may use one type of cooling and the second a different type of cooling, and/or the first interval may use a first number and/or capacity of cooler and the second a different number of coolers and/or different capacity of cooler (e.g., higher number and/or capacity). In the example above, when needed, a refrigeration type cooler can be temporarily used to temporarily drop the temperature of the drilling fluid at surface, for example to 32° C. Although described with respect to only two intervals, three, four or additional intervals, one or more of which having different cooling, can be implemented. Thus, the use of surface cooling and type of surface cooling can be selected based on the specified maximum and/or minimum drilling fluid temperatures, discussed above, which in turn are determined based on the maximum rated temperatures of the tools in the BHA 210, and, in certain instances, the tubing 202 itself, specified maximum target and/or minimum temperatures determined based on the life/temperature relationship and performance/temperature relationship of the tools, and/or temperatures for shock cooling.

Another thermal control technique can include supplying cool fluid through one of multiple tubes in the drilling string to cool the drilling fluid flowing to the BHA 210 and drill bit 208. As described in more detail with respect to FIGS. 8-9, and briefly discussed, the drilling string 200 can have multiple tubes with one or more of the tubes being coupled to the drilling bit 208 for supplying drilling fluid to the BHA 210 and drilling bit 208. In certain instances, cooling fluid that has been cooled at the surface (e.g., via cooler 230) can be flowed through one or more of the other tubes, which are in close proximity and, in certain instances, contact with the tube(s) flowing the drilling fluid, to cool the drilling fluid. Additionally, or alternatively, the cooling fluid can be selected based on its thermal characteristics to insulate the drilling fluid from the heat in the annulus around the drilling string 200. In certain instances, the cooling fluid can be the cooling fluid that is released into the annulus, as discussed above, or it can be recirculated through other of the tubes to the surface. Thus, the use of cooling fluids in a multi-tube the drilling string 200, the number of tubes including the cooling fluid, and the types and flow rates of fluids used can be selected based on the specified maximum and/or minimum drilling fluid temperatures, discussed above, which in turn are determined based on the maximum rated temperatures of the tools in the BHA 210, and, in certain instances, the tubing 202 itself, specified maximum target and/or minimum temperatures determined based on the life/temperature relationship and performance/temperature relationship of the tools, and/or temperatures for shock cooling.

In developing a drilling plan to drill the geothermal well 102, the drilling string 200 configuration is determined, as well as how the drilling string 200 will change over a drilling run as tubing 202 is added. This analysis includes determination of the configuration of the BHA 210 (e.g., the tools included in the BHA 210, the drilling bit type and characteristics, maximum rated operating temperatures of the BHA 210 tools, life/temperature and/or performance/temperature relationships of the BHA 210, and/or other aspects) and the arrangement of tubing 202 and other tools (e.g., arrangement of insulated and/or uninsulated tubing, the number of tubing intervals, number, position/location and characteristics of insulated tubing in each interval, the number and position of fluid diverters and/or separators, if any, the use of multitube drilling string and/or other aspects). The drilling string 200 configuration is selected together with the selection of the drilling fluid (composition, thermal properties, flow rate and/or other aspects), and if and how the drilling fluid will be changed over the drilling run, and additional operational aspects, such as whether and when to use cooling fluid, whether and when to use coolers 230 and the configuration of the coolers 230 (cooler type, number, cooling capacity and/or other aspects). The characteristics of the drilling runs, including the number of runs (tripping the drilling string 200 in, drilling, and tripping the drilling string 200 out), the target drilling interval for each run, and/or other aspects, are also determined together with the aspects above. Each of the lateral wellbores 150 may drilled in one or multiple runs, with a preference to drilling each lateral wellbore 105 in the fewest (or one) runs.

The plan is iteratively developed using mathematical and/or numerical analysis models of the heat transfer and drilling, and with each aspect determined based on the other, as well as based on the characteristics of the well 102 and wellbores (e.g., length, depth, number, and/or relative position of lateral wellbores 150/connecting wellbores 140 and/or other aspects) and the subterranean zone 104 (e.g., geomechanical and geothermal characteristics of the zone 104, including rock type, elastic modulus, strength, geothermal gradient, temperature, temperature gradient and/or other aspects). The plan is developed based on maintaining the BHA 210, and, in certain instances, the tubing 202 itself, below the maximum rated temperatures of the tools and/or tubing therein over an entire drilling run, and in certain instances, on maintaining, over an entire drilling run or during certain intervals in a drilling run, minimum target and/or maximum temperatures based on the life/temperature and/or performance/temperature relationships of the BHA 210 tools and/or tubing. The plan may be developed iterating different configurations of BHA 210 tools and drilling string 200 with different thermal control techniques and characteristics of the well and wellbores.

In certain instances, the drilling plan can be developed based not only maintaining the temperature of the mud motor 212 below the maximum rated operating temperature, but also on a maximum target operating temperature and/or a minimum target operating temperature determined based on the life/temperature and/or performance/temperature relationship of the mud motor 212. The minimum target operating temperature, in certain instances, can be above or below the minimum rated temperature of the mud motor 212, and/or the maximum target operating temperature can be above the maximum rated temperature. For example, to reach a target drilling distance (e.g., measured depth) with a single trip, two trips or the fewest trips, the minimum and/or maximum target operating temperatures can be selected based on the target drilling distance, a target number of trips to the distance, and a temperature range in the life/temperature relationship that will achieve the target drilling distance in the target number of trips. Additionally, or alternatively, to maintain a certain performance of the mud motor 212 (e.g., a specified efficiency at or above a threshold efficiency), the minimum target operating temperature and/or maximum target operating temperature can be selected based on the target performance characteristic or characteristics and a temperature and/or temperature range in the performance/temperature relationship that will achieve the target performance characteristic or characteristics.

In certain instances, the drilling plan can be developed based not only maintaining the temperature of the sensor based tools, including the measurement subs 216 and/or ranging tool 218, below their maximum rated operating temperature, but also on a maximum target operating temperature and/or a minimum target operating temperature determined based on the life/temperature and/or performance/temperature relationship of one, multiple or all of the sensor based tools. The minimum target operating temperature, in certain instances, can be above or below the minimum rated temperature of the particular sensor based tool, and/or the maximum target operating temperature can be above the maximum rated temperature. For example, the minimum and/or maximum target operating temperatures can be selected based on the target measurement accuracy and a temperature and/or temperature range in the performance/temperature relationship that will achieve the target measurement accuracy. Different minimum target operating temperatures and/or maximum target operating temperatures can be determined for different ones of the sensor based tools based on the desired accuracy and the performance/temperature relationship. Additionally, or alternatively, the minimum and/or maximum target operating temperatures can be selected based on a target tool life (e.g., reliability against failure) and a temperature and/or temperature range in the life/temperature relationship that will achieve the target tool life. Different minimum target operating temperatures and/or maximum target operating temperatures can be determined for different of the sensor based tools based on the target tool life and the life/temperature relationship. Furthermore, different minimum and/or maximum target operating temperatures can be determined for different drilling depths. For example, a different minimum and/or maximum target operating temperature can be selected to target a higher measurement accuracy (than elsewhere in the drilling) at a specified depth or over a specified depth interval that requires or would benefit from the higher measurement accuracy. Locations of wellbore intersection and parallel wellbores in close proximity are two examples of where higher measurement accuracy may be needed or beneficial.

In certain instances, the drilling plan can be developed based not only maintaining the temperature of batteries (and tools having batteries) below their maximum rated operating temperature, but also on a maximum target operating temperature and/or a minimum target operating temperature determined based on the life/temperature and/or performance/temperature relationship of the batteries. The minimum target operating temperature selected for a battery, in certain instances, can be above or below the minimum rated temperature of the battery, and/or the maximum target operating temperature can be above the maximum rated temperature. For example, to reach a target drilling distance (e.g., measured depth) with a single trip, two trips or the fewest trips, the minimum and/or maximum target operating temperatures can be selected based on the target drilling distance, a target number of trips to the distance, and a temperature range in the life/temperature relationship that will achieve the target drilling distance in the target number of trips. Additionally, or alternatively, to maintain a certain performance of a battery (e.g., a specified discharge efficiency at or above a threshold efficiency), the minimum target operating temperature and/or maximum target operating temperature can be selected based on the target performance characteristic or characteristics and a temperature and/or temperature range in the performance/temperature relationship that will achieve the target performance characteristic or characteristics.

In certain instances, involving temperature sensitive tubing, the drilling plan can be developed based not only maintaining the temperature of tubing below its maximum rated operating temperature, but also on a maximum target operating temperature determined based on the life/temperature and/or performance/temperature relationship of the tubing material.

In each instance above, by using the thermal control techniques described herein, the BHA 210 tools can be of a lower maximum rated temperature than would be required without the thermal control techniques herein, because the maximum temperature experienced by the tools is lower than those that would have been experienced without the cooling techniques. Enabling use of tools with lower maximum rated temperature can enable features that would not be possible or that would be more difficult to implement in tools with a higher maximum rated temperature. For example, processors and memories for downhole processing of data are difficult to ruggedize for high temperature, and so are omitted on many tools with high maximum rated temperatures. However, tools with lower maximum rated temperatures, such as measurement subs 216 and ranging tools 218, can benefit from downhole processing of data. For example, using the thermal control techniques herein enables use of a ranging tool 218, as discussed above, that can process the raw sensor data downhole and send the less bandwidth intensive (than the raw data) distance and direction data which is more feasible to send over mud pulse telemetry in a practical timeframe. Also, enabling use of tools with lower maximum rated temperature can have other benefits, such as reduced cost (higher temperature rated tools are more expensive than lower temperature rated tools) and greater availability (higher temperature rated tools are specialty tools, and more difficult and/or timely to procure).

In certain instances, the specified minimum and/or maximum target operating temperatures of one tool may be prioritized over similar temperatures of other tools in the BHA 210. For sake of example, in certain instances, the accuracy of the ranging tool 218 may be prioritized over the accuracy of the measurement subs 216, because the need for accuracy of the ranging tool 218 may be greater, especially if performing an intersection of wellbores. Thus, if the maximum target operating temperature determined for accuracy of the ranging tool 218 is lower than the maximum target operating temperature determined for the target accuracy desired for other of the measurement subs 216, then the drilling plan, and the thermal control techniques implemented, will be selected to maintain the maximum target operating temperature determined for the ranging tool 218 rather than for the other measurement sub 216. In other words, the drilling plan, and the thermal control techniques implemented, will be selected based on the performance/temperature relationship of the ranging tool 218. Priority can be given to other tools in the BHA 210 in a similar manner depending on the drilling objectives. Likewise, priority may be given to the specified maximum temperatures needed shock cooling effect over the specified minimum and/or maximum target operating temperature of any of the tools in the BHA 210.

Furthermore, while priority is given to one tool in the BHA 210 over others or to the shock cooling effect, the specified minimum and/or maximum target operating temperatures of other tools or the needs for shock cooling can also be taken into account. For example, if priority is given to the specified maximum target operating temperature determined for the ranging tool 218, as in the example above, and/or the needs for shock cooling, the drilling plan, and thermal control techniques implemented, can be based on a specified minimum target temperature of another tool, such as a measurement sub 216 and/or another tool with a battery.

Also, the priorities can be different during different intervals of a drilling run. For example, the specified maximum target temperature determined for the ranging tool 218 based on the performance/temperature relationship to yield a specified accuracy may only be needed at times when the ranging tool 218 is operated to determine relative distance and direction to another wellbore (e.g., when intersecting wellbores and periodically when drilling parallel wellbores). Thus, the drilling plan, and thermal control techniques implemented, may be selected to prioritize the specified maximum target temperature determined for the ranging tool 218, for example by running a cooler 230 (or a different number and/or type of coolers 230) and/or changing drilling fluids, only for intervals when the ranging tool 218 will be operated. During the remaining intervals, the drilling plan may be selected to target another tool's specified maximum target temperature and/or the needs for shock cooling.

In certain instances, the same and/or same types of thermal control techniques described above can be used to drill all of the wellbores of the systems shown in FIGS. 1A and 1B. In other instances, the thermal control techniques used to drill the connecting wellbores 140 (and the lateral wellbores 150 that form the connecting wellbores) may be different from those used to drill the inlet and outlet surface wellbores 120, 130. For example, because the highest temperatures can be encountered in the formations through which connecting wellbores 140 are drilled and lower temperatures encountered in the formations through which the inlet and outlet wellbores 120, 130 are drilled, some (e.g., fewer) or none of the thermal control techniques used to drill the connecting wellbores 140 may be used in drilling the inlet and outlet surface wellbores 120, 130. Similarly, shock-cooling can have a greater effect on ROP when the rock is hot, for example, above 250° C. The ROP advantage may be less in the inlet and outlet surface wellbores 120, 130, and much more significant in drilling a network of connecting wellbores 140 drilled at depth within hot rock, such as the examples shown in FIGS. 1A and 1B. Therefore, the thermal control techniques can be configured to effect the shock-cooling in wellbores where the majority of the drilling is within very hot rock.

In accordance with some aspects, a method for drilling a wellbore, as part of a geothermal well or for another well in a hot subterranean zone, includes determining a drilling plan for drilling the wellbore to a target measured depth using a drilling string configured to convey a drilling fluid to a BHA. The drilling plan includes constructing the drilling string by attaching to an uphole end of the drilling string as the wellbore is being drilled, specified tubular segments of varying thermal resistance in a specified sequence. The specified sequence is such that (a) a majority of the tubing of an upper portion of the drilling string be insulated or have a specified (e.g., high or increased over conventional tubing) thermal resistance (b) a total thermal resistance of a lower portion of the drilling string nearer to the BHA remains less than that of the upper portion of the drilling string, and/or (c) as the wellbore is drilled to the target measured depth, a temperature of the drilling fluid at the BHA neither substantially exceeds nor substantially falls below a maximum target and/or minimum fluid temperature, as discussed above. Once the drilling plan has been established, the wellbore is drilled and the thermal control techniques applied according to the plan. In other words, the BHA and drilling string are assembled in accordance with the plan, the determined fluids used, the determined coolers used and the determined flow rates are implemented. As conditions change, or if unexpected circumstances arise, the drilling plan can be reassessed and, if needed, revised and further drilling conducted in accordance with the revised drilling plan.

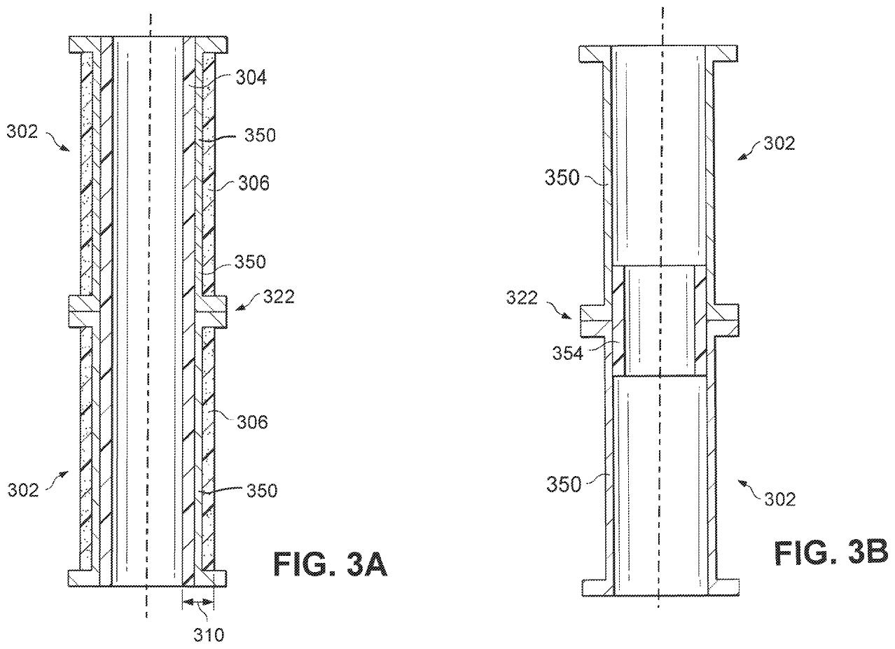

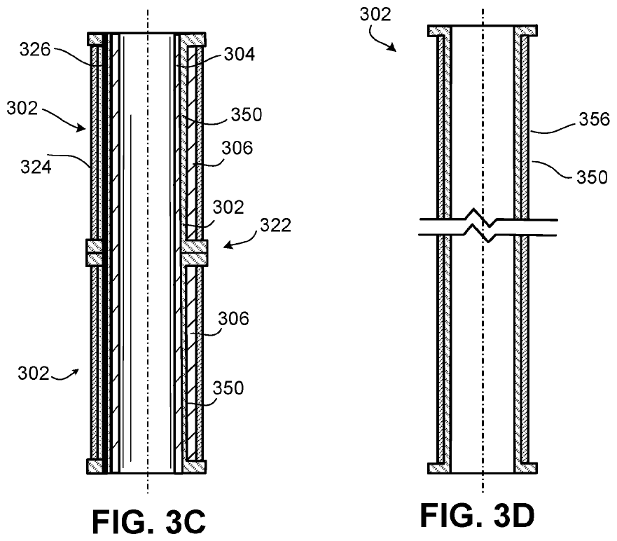

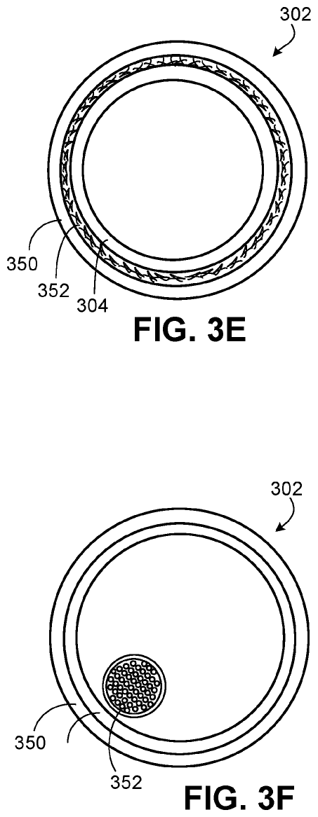

FIG. 3A illustrates example insulated tubing 302 (e.g., drill pipe and/or coiled tubing) that can be used as tubing 202 of FIGS. 2A-2C. Two lengths of tubing 302 are shown connected to each other at connectors 322, which are typically (but not necessarily) pin and box threaded connectors. In the context of drill pipe, the tubing 302 is relatively rigid and provided in short lengths, referred to as “joints” of tubing. In certain instances, the joints are approximately 30 ft long. In the context of coiled tubing, the tubing 302 is relatively flexible, designed to be coiled on and off a spool (e.g., spool 236). In certain instances, the coiled tubing can be provided in lengths from 500 m to 5,000 m or longer, although any length can be provided and used herein.

Each tubing 202 includes a main body 350. In some instances, the main body 350 is carbon or chrome moly steel, aluminum alloy, titanium alloy, fiber composite (e.g., a composite of carbon fiber, aramid fiber, fiberglass, e-glass and/or other structural fiber in a resin binder), and/or polymer (e.g., entirely polymer or polymer reinforced with fiber such as carbon, aramid, fiberglass, e-glass or other structural fiber). The tubing 302 includes an insulative inner coating layer 304 covering (entirely or partially) the inner circumferential surface of tubing 302. The insulative inner coating layer 304 is configured with a specified thermal resistance against conductive heat transfer through the coating, and thus into the main body 350 of the tubing 302. In the illustrated instance, the inner coating layer 304 covers the entire inner surface of the tubing 302, including the full length of tubing 302 and the inner surface of connector 322. By covering the inner surface of connector 322 with inner coating layer 304, heat transfer through the tubing 302 at the connector 322 is reduced.

The tubing 302 is also shown with an outer coating layer 306 covering (entirely or partially) the outer circumferential surface of the tubing 302. In the illustrated instance, connector 322 has a larger diameter than the main portion of body 350 and thus can be exposed to more contact and resulting greater friction against the wellbore wall or other components of the wellbore system. In the illustrated instance, outer coating layer 306 covers the portion of tubing 202 between connectors 322 but not the larger diameter area around connectors 322. In this way, outer coating layer 306 is less exposed to friction occurring at connectors 322.

In some instances, inner coating layer 304 comprises one or more of epoxy novolac resins and epoxy phenolic resins. In certain instances, the thickness of inner coating layer 304 comprising the epoxy phenolic resin ranges from 150 to 250 μm. In certain instances, the thickness inner coating layer 304 comprising the epoxy novolac resins ranges from 400 to 1270 μm. In certain instances, the epoxy phenolic resins have an average thermal conductivity of ˜0.8 W/m K (Watts per meter Kelvin). In certain instances, the epoxy novolac resin has an average thermal conductivity of ˜0.4 W/m K. Insulating particles can be added to these resins, or others, to further reduce the thermal conductivity.

In some instances, outer coating layer 306 comprises a fiber composite overwrap (such as carbon fiber composite, an e-glass composite and/or another fiber composite) overwrap of about 2540 μm thickness. In certain instances, e-glass has a thermal conductivity of about 0.288 W/m K. In certain instances, carbon fiber has a thermal conductivity of about 0.8 W/m K.

In some instances, a length normalized, bulk, radial thermal resistance of a wall of the tubing string is at least about 0.002 K m/W (Kelvin meter per Watt). In some instances, a length normalized, bulk, radial thermal resistance of a wall of the tubing string is at least about 0.01 K m/W. Referring to FIG. 3A, the thickness 310 of the wall is defined by the inner surface of inner coating layer 304 and the outer surface of outer coating layer 306. For purposes, “length normalized thermal resistance” is the effective conductive thermal resistance of the string for radial heat transfer, considering the varying materials along its length, and is the temperature difference required to transmit 1 watt of energy over an axial material length of 1 meter.

Below is the length normalized thermal resistance of the wall of the tubing string in some instances having a steel main body 350 and an inner coating layer 304 including materials and thicknesses as indicated (but no outer coating layer 306).

| | Length-normalized |
|---|---|
| Coating layer | Thermal Resistance |
| epoxy phenolic 100 μm | 0.00062K m/W |
| epoxy phenolic 250 μm | 0.0010K m/W |
| epoxy novolac 250 μm | 0.0017K m/W |
| epoxy novolac 400 μm | 0.0024K m/W |

Below is the length normalized thermal resistance of the wall of the tubing string in some instances having a steel main body 350 and an inner coating layer 304 of the materials and thicknesses as indicated plus an outer coating layer 306 (“jacket”) of e-glass of a thickness as indicated:

| | Length-normalized |
|---|---|
| Coating layers | Thermal Resistance |
| epoxy phenolic 100 μm + | 0.0032K m/W |
| 2.5 mm jacket | |
| epoxy phenolic 100 μm + | 0.0034K m/W |
| 5 mm jacket | |
| epoxy phenolic 250 μm + | 0.0048K m/W |
| 2.5 mm jacket | |
| epoxy phenolic 250 μm + | 0.0054K m/W |
| 5 mm jacket | |
| epoxy novolac 250 μm + | 0.0070K m/W |
| 2.5 mm jacket | |
| epoxy novolac 250 μm + | 0.0082K m/W |
| 5 mm jacket | |
| epoxy novolac 400 μm + | 0.0092K m/W |
| 2.5 mm jacket | |
| epoxy novolac 400 μm + | 0.011K m/W |
| 5 mm jacket | |

In certain instances, tubing 302 as illustrated in FIG. 3A has an inner coating layer 304 of an epoxy novolac resin with a thickness of about 400 microns and an e-glass outer coating layer 306 with a thickness of about 5 millimeters. In such an instance, assuming a subterranean zone with a thermal gradient of about 60° C./km and drilling string with a length of about 8,000 m and water-based drilling fluid with a circulation rate of about 3 m³/min, and a temperature at the rock face of about 490° C., such a drilling string 200 assembled entirely or substantially of such tubing 302 can result in a temperature difference between the rock adjacent the rock face and the drilling fluid at the rock face of about 346° C.

In certain instances, tubing 302 as illustrated in FIG. 3A having an inner coating layer 304 of an epoxy phenolic resin with a thickness of about 250 microns and a e-glass outer coating layer 306 with a thickness of about 2.5 millimeters. In such an instance, assuming a subterranean zone with a thermal gradient of 40° C./km and tubing string with a length of about 9,000 m and water-based drilling fluid with a circulation rate of about 3.5 m³/min and a temperature at the rock face of about 370° C. such a drilling string 200 comprised of such tubing 202 can result in a temperature difference between the rock adjacent the rock face and the drilling fluid at the rock face of about 196° C.

In other instances, inner coating layer 304 and/or outer coating layer 306 can have a greater or lesser thickness and/or can be or include other types of coatings, for example, ceramic inorganic coatings such as silicate-bonded ceramics.

FIG. 3B illustrates another configuration of insulated tubing 302. The tubing 302 of FIG. 3B is similar to that of FIG. 3A, except as described below. The inner coating layer 354 at least partially covers an inner circumferential surface of tubing 302. In the illustrated instance, inner coating layer 354 covers only the inner circumferential surface of tubing 302 at and proximate to connector 322. By covering the area of inner circumferential surface of tubing 302 at and proximate to connector 322 with inner coating layer 354, heat transfer at connector 322 is reduced. In other instances, inner coating layer 354 covers the entire inner circumferential surface of tubing 302.

In some instances, inner coating layer 354 of FIG. 3B can comprise the same materials and thicknesses as described in reference to inner coating layer 304 of FIG. 3A. In some instances, inner coating layer 354 can comprise other suitable materials or thicknesses. In some instances, tubing can comprise vacuum-insulated tubing (VIT) wherein insulation is provided by a vacuum layer within tubing, instead of or in addition to inner coating layer 304 (or 354) and outer coating layer 306.

FIG. 3C illustrates another configuration of insulated tubing 302. The tubing 302 of FIG. 3C is similar to that of FIG. 3A, except as described below. Notably, the tubing of FIG. 3C is a double wall insulated tubing 302, having an additional outer tubing 324 wholly encasing the layer 306. The outer tubing 324 provides a protective later to the layers beneath that bears the contact and impact inherent in drilling and shields the layers beneath. The outer tubing 324 allows use of more delicate insulative materials as layer 306, because the layers beneath need not withstand the contact and impact that the outer layer 306 of FIG. 3A must. Accordingly, layer 306 can be of a different construction (e.g., thicker, of a higher thermal resistance material) than the outer coating layer of the tubing 302 of FIG. 3A. The inner layer 304 can be omitted in the insulated tubing 302 of FIG. 3C, or provided over only a portion of the inner circumference of the tubing 302. In certain instances, the inner layer 304 can be provided covering the inner circumference near the connectors 322 while leaving the middle portion of the tubing 302 exposed. In certain instances, a wire 326, such as an electrical conductor, fiber optic line, and/or other type of wire extends through the tubing 302. The wire 326 is configured to communicate signals (e.g., data, values, communications and/or other signals) and/or power through the tubing 302 and, in certain instances, is configured to couple to one or more of the tools in the BHA 210 (FIG. 2A), including the communication tool 220, to communicate signals and/or power with the tools of the BHA 210. While the wire 326 can be provided in any of the embodiments, in the tubing 302 of FIG. 3C, the wire 326 can be mostly housed in the space between the body 350 and the outer tubing 324 with only end portions of the wire 326 extending into the connectors 322. The wire 326 can be positioned in the connectors 322 such that as lengths of the tubing 302 are connected together, the connectors 322 mate and provide continuity of the wire 326 to pass signals and/or power between each of the lengths of tubing 302.

FIG. 3D illustrates another configuration of insulated tubing, specifically an insulated coiled tubing 302. While the coiled tubing 302 can include the interior and/or exterior coatings described herein, FIG. 3D shows an example polymer coiled tubing with a protective sheath 356, where the polymer of the coiled tubing is configured to provide insulation. The sheath 356 is constructed of a material with a relatively higher abrasion resistance to that of the polymer, such as steel, aluminum, titanium and/or another material, and can be relative thin so that it does not substantially add to the weight of the tubing. In certain instances, the sheath 356 is 7 mm or thinner. In certain instances, the length normalized, bulk, radial thermal resistance of the polymer coiled tubing 302 is at least 0.02 m K/W, and in certain instances greater than 0.05 m K/W, 0.2 m K/W or 0.3 m K/W. These values may be achieved by selecting the thermal conductivity of the polymer and its thickness. In certain instances, the thermal conductivity range is approximately 0.15-0.5 W/m K. In certain instances, the coiled tubing 302 has a dry density of less than 2000 kg/m³, and in certain instances less than 1500 kg/m³. At this density, the wet weight of the tubing 302 once submerged in the wellbore drilling fluid is minimal. Typical drilling fluids have densities ranging from 1.0-2.0 Specific Gravity (although they can be higher or lower). Therefore, such an insulated tubing 302 would have excellent thermal resistance, sufficient hydraulic flow capacity, negligible impact on the wet (floating) weight of the drilling string, no external abrasion issues, and it can be handled the same as regular coiled tubing during operations. The polymer coil tubing may have multiple concentric layers of differing polymer and other materials bonded together. In certain instances, the tubing has a “dry weight” tensile specific strength of at least 50 kN*m/kg, but when tubing is submerged in drilling fluid (“wet weight”), the specific tensile strength of the tubing is at least 150 kN*m/kg as the weight of the tubing is buoyed by the drilling fluid.

In certain instances (e.g., for communicating with a rotary steerable system, drilling with a contactless drilling bit and/or in other instances) the tubing 302 of any of the configurations above, can include an umbilical cable having conductors (e.g., electrical, fiber optic, hydraulic and/other types) for power and/or communication to from an uphole location and/or the terranean surface to the BHA 210. In certain instances, the umbilical cable can be clamped to the exterior of the tubing 302, or as shown in FIG. 3E, an umbilical cable 352 can be routed through the interior of the tubing 302. In certain instances, the umbilical cable can be routed into a bore through a sidewall of the main body 350 and/otherwise integral with the main body 350. In certain instances, as shown in FIG. 3F, the umbilical can be implemented as conductors 352 between layers of the tubing 302. The umbilical configurations of FIGS. 3E and 3F can be implemented in any of the tubing embodiments described herein.

In certain instances, the main body 350 in any of the embodiments above can comprise a high strength-to-weight ratio steel drill pipe such as UD165 steel drill pipe available from NOV, Inc. In some instances, such steel drill pipe can be UD-165 steel drill pipe that can have a yield strength of about 165,000 psi (1,138 MPa), a tube tensile strength of about 1,000,000 lbf (4.45 MN), a length normalized joint air weight of 24.76 lbf/ft (361.3 N/m), and a joint strength to weight ratio of about 900 lbf/lbf (900 N/N) in a 5.875 inch (14.92 cm) outer diameter drill pipe.

In some instances, main body 350 can comprise a tubing made of a titanium alloy. In some instances, such titanium alloy tubing can comprise Ti-6Al-4V titanium alloy and can have a yield strength of about 120,000 psi (827 MPa), a tube tensile strength of about 750,000 lbf (3.34 MN), a length normalized joint air weight of 16 lbf/ft (233.8 N/m), and a joint strength to weight ratio of about 1,000 lbf/lbf (1000 N/N) in a 5.875 inch (14.92 cm) outer diameter drill pipe.

In some instances, main body 350 can comprise a tubing made of an aluminum alloy. In some instances, such an aluminum alloy tubing can comprise Al—Zn—Mg II aluminum alloy and can have a yield strength of about 70,000 psi (483 MPa), a tube tensile strength of about 600,000 lbf (2.67 MN), a length normalized joint air weight of 15.5 lbf/ft (226 N), and a joint strength to weight ratio of about 825 lbf/lbf (825 N/N) in a 5.787 inch (14.699 cm) outer diameter drill pipe. In some instances, such an aluminum alloy pipe can comprise FarReach™ drill pipe available from Alcoa Energy Systems. In some instances, such aluminum alloy drill pipe can comprise aluminum drill pipe available from Aluminum Drill Pipe, Inc.

In some instances, main body 350 can be a carbon fiber composite tubing. In some instances, such carbon fiber composite tubing can be Advance Composite Drill Pipe available from Advance Composite Products & Technology, Inc.

In some instances, drilling string 200 can be made entirely of tubing having the same construction, e.g., main bodies 350 of the same material. In other instances, drilling string 200 can include two, three or more different intervals (i.e., different portions) with one or more lengths of tubing within each interval having the same main body 350 material and one or more of the intervals having a different main body 350 material than other of the intervals. For example, in some instances, some of the tubing, i.e., a first interval, can have tubing of one main body material and the remainder of the tubing of drilling string 200 can be another main body material (such as steel).

In another instance, a majority of the tubing in a portion close to the drilling bit 208 be main bodies of a material lighter than the portion further uphole from drilling bit 208, on a length-normalized air weight basis. For the examples above, titanium drill pipe is about 35% lighter than steel and aluminum drill pipe is about 37% lighter. Those tubing 202 in a portion further uphole from drilling bit 208 may include main bodies with a higher strength material. For the examples above, UD-165 drill pipe has a tensile strength about 67% greater than aluminum, and titanium drill pipe has a tensile strength about 25% greater than aluminum. The difference in tensile strength and length-normalized weight can also be achieved with a single material, but with varying thicknesses/diameter of tubing in the uphole portion compared to the downhole portion in a telescoping manner. In one instance, the majority of the tubing 202 in the portion close to the drilling bit are about 35% lighter than the majority of the tubing 202 in the uphole portion, and a majority of the tubing 202 in the uphole portion have a tensile strength are about 25% higher than a majority of the tubing 202 in the portion close to the drilling bit. Such use of different drilling string materials can enable drilling of much higher temperature rocks which exist at greater depths, and hence require an insulated drilling string which has sufficient tensile strength to extend to such depths. The above mentioned materials, when combined appropriately, enable drilling at depths of greater than 9 km, including up to 14 km or greater. The earth's geothermal gradient causes rocks at greater depths to have higher temperatures. The present shock cooling technology provides a method to increase rate of penetration and drilling performance in high temperature rock. Hence there is a synergistic effect from combining deeper drilling, enabled by combining different weight/strength drill pipe segments, with the cooling technology described herein. The closed loop multilateral wells can be drilled at a sufficient depth (and hence, rock temperature) so that the shock-cooling effect is enabled, thus greatly reducing the time and cost of drilling the multilateral wellbores.

In certain instances, the tubing 202 construction can be selected, together with the drilling fluid, to enable the drill string 200 to be buoyed or at least partially buoyed by the drilling fluid in the wellbore. For example, in drilling with a contactless type drill bit, significant weight on bit is not required to effect the drilling. The bit simply needs to be maintained in close proximity to the rock face it is drilling. Selection of main bodies 350 that are composite and/or polymer enables achieving a ratio of tubing and/or drilling string bulk density to drilling fluid bulk density of 2, and in certain instances 1.5 or less, so that drilling string 200 is at least partially buoyed by the fluid and the string's floating weight to be much less than main bodies 350 of steel. The target ratio can account for things in the drilling string that are not tubing, such as the BHA and umbilical cable, and the mix of different types of tubing 202 (e.g., different main body materials) so that the total ratio is 2.0 or greater. At least partially buoying the drilling string 200 in this manner reduces the forces between the string and the wellbore walls, and thus the sliding friction, making it easier and requiring a smaller, less powerful surface rig (with a smaller hoist) to move very long drilling strings through the wellbores. Furthermore, at least partially buoying the drilling string 200 in this manner also reduces the tensile forces on the drilling string 200, allowing longer drilling strings and thus longer wellbores to be drilled, as well as and greater freedom in selecting the tubing 202 construction to achieve the minimum/maximum specified temperatures, discussed above.

In one example, a tubing 202 with a composite and/or polymer main body 350 can have a density of approximately 1.3 SG (typical of polymers) to 2 SG (typical fiber composites range from 1.5-2 SG), and for the sake of this example, approximately 1.5 SG. When submerged with a drilling fluid that is primarily water (i.e., approximately 1 SG), the ratio of densities is 1.5. By comparison, typical steel is 7.8 SG, so a tubing 202 with a steel main body 350 in a water drilling fluid will have a ratio of densities of approximately 7.8.

Additionally, the buoyancy of the drilling string 200 can be controlled by controlling the drilling fluid density (i.e., composition). For example, a less dense drilling fluid than will be used at an operating buoyancy state (e.g., the 2-1.5 ratio discussed above) can be provided into the wellbore when running the drilling string 200 into the wellbore to reduce the buoyancy, and make running the drilling string 200 in easier and faster. Then, a more dense drilling fluid than used at the operating drilling buoyancy state can be provided into the wellbore when running the drilling string 200 out of the wellbore to increase the buoyancy, and make running the drilling string 200 out easier, faster, and reduce the stress on the drilling string 200 and drilling rig. The drilling fluid density can be adjusted by modifying the inlet temperature, modifying inlet pressure (when operating with managed pressure drilling), changing the dissolved solids/salts and solids content in the fluid. Furthermore, in certain instances, a tractor can be used to apply a force to the drilling string 200 to pull it through the wellbore, and agitator/vibration tools can be used to reduce sticking friction of the drilling string 200 in the wellbore.

In certain instances, a carbon steel tubing with an interior coating having a 400 μm thickness of epoxy novolac over the entire length (and no exterior coating) can produce an approximately 91° C. greater temperature differential between the internal fluid flow and the rock formation in a 5000 meter drilling string as compared to the same length of uninsulated carbon steel tubing, using a water drilling fluid pumped at about 3.5 m³/min and a temperature gradient from the surface of the earth to the rock face of about 50° C./km.

In certain instances, a carbon steel tubing with an interior coating having a 400 μm thickness of epoxy novolac and an exterior coating of 5 mm e-glass jacket, both over the entire length, can produce an approximately 346° C. temperature differential between the internal fluid flow and the rock formation in an 8000 meter string as compared to the same length of uninsulated carbon steel tubing, using assumes a water drilling fluid pumped at about 3.5 m³/min and a temperature gradient from the surface to the rock face of about 60° C./km.

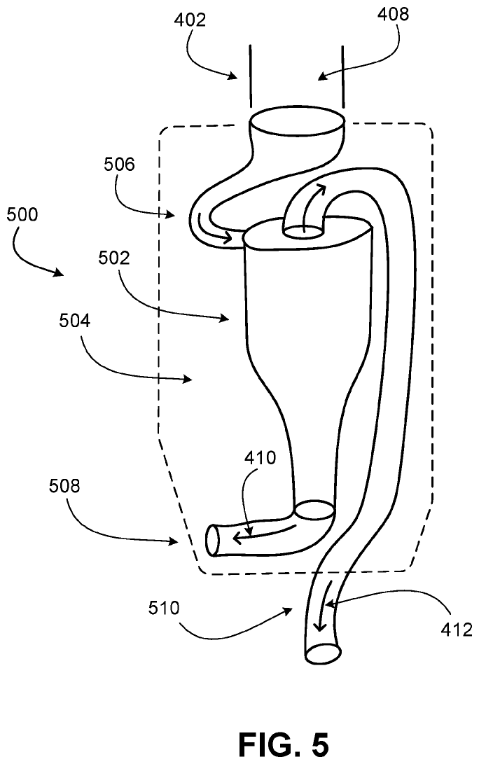

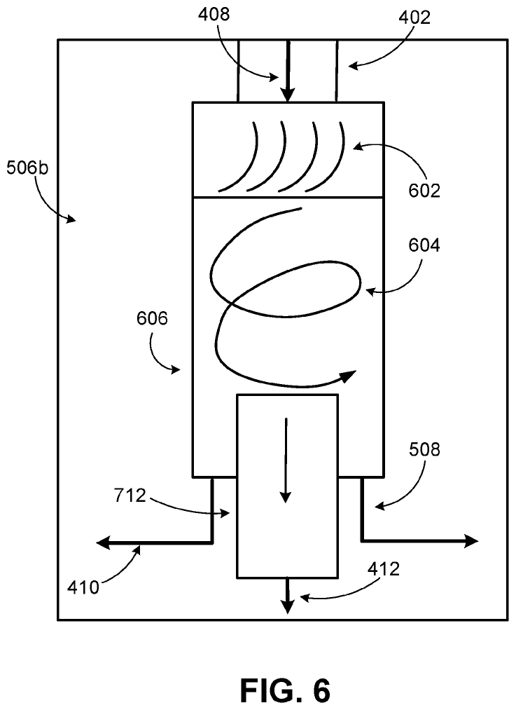

As discussed above in reference to FIGS. 2A-2C, a drilling string can be configured with a downhole separator to separate and divert a water-rich (and thus high heat-capacity) stream into the annulus, while the relatively oil-rich remaining stream flows to the drill bit for lubricity, chemical stability, and (if applicable) dielectric properties. In certain instances, the water rich stream can be diverted into the annulus for the purposes of enhanced cooling of the exterior of the drilling string tubing (and the exterior of other components uphole of the separator), while the oil rich stream is passed on to the drilling bit. Furthermore, the separators may remove heavy impurities from the drilling fluid that can negative impact bit/rock interaction and drilling performance. FIG. 4 illustrates detail of an example drilling string 400 that could be used as drilling string 200 of FIGS. 2A-2C in some instances. Drilling string 400 includes tubing 402 with a drilling bit 404 that in some instances could be tubing 202 and drilling bit 208 of FIGS. 2A-2C, respectively. Drilling string 400 further includes a fluid separator 406 uphole of drilling bit 404 that could be separator 204 in FIGS. 2A-2C. In some instances, separator 406 can be a cyclone separator, a powered centrifuge, or another type of separator. In some instances, for example, separator 406 can be separator 500 of FIG. 5 or separator 600 of FIG. 6.

While drilling with drilling string 400, drilling fluid 408 is flowed through an interior of the tubing 402 and through the fluid separator 406. Fluid separator 406 separates out from the drilling fluid a relatively water-rich fluid stream 410 from drilling fluid 408 (that is, stream 410 has a higher water-to-oil ratio than remaining portion 412 of the drilling fluid 408) and diverts stream 410 to annulus 414 surrounding the tubing 402. From separator 406, remaining portion 412 (having a lower water-to-oil ratio as compared to diverted stream 410) flows to drilling bit 404. One or more separators 406—alone or in conjunction with diverter tools (such as diverter tools 204 of FIGS. 2B-2C)—can be positioned and configured based on specified target temperature or temperatures of tubing 402 (or portions of tubing 402 and/or other components uphole or downhole of the separator) to be cooled by the water-rich stream, and also based on specified parameters of the oil-rich stream for operation of drill bit 404 (for example, lubricity, chemical stability, and dielectric properties). The specified target temperature can be a rated operating temperature or temperature range that is typically specified by the manufacturer and is below the maximum rated operating temperature. Thus, specified temperatures or temperature ranges can be established based on the operational life/temperature and/or performance/temperature relationships and the drilling operations configured to maintain the tubing or other components the specified target operating temperature or in temperature ranges. The separators 406 can include one or more actuable valves, orifices and/or ports, actuable from the terranean surface hydraulicly, electrically, mechanically, chemically and/or otherwise, to control the flow and pressure into and/or around the separator 406. In certain instances, one or more of the separators 406 can be placed in the string 400 downhole of any mud turbine electric generator so as not divert fluid flow that would otherwise drive the mud turbine electric generator. An umbilical in or coupled to the tubing 402 can be used to supply power from the mud turbine electric generator to components below. Alternately, the separator 406 and its impact on fluid flow can be accounted for in selecting the characteristics of the mud turbine electric generator and in determining the fluid flow to ensure the needed power generation is achieved.

FIG. 5 illustrates detail of an example fluid separator 500 that in some instances could be used as fluid separator 406 of FIG. 4. Separator 500 includes a cyclone chamber 502 within a housing 504. An inlet 506 of cyclone chamber 502 is configured to receive drilling fluid 408 from tubing 402. The drilling fluid enters the cyclone unit tangentially. An outer vortex is generated in the cyclone which imparts a centripetal force that drives separation between the lower density oil phase and higher density water phase. The heavier water phased exits as water-rich stream 410 from outlet 508 to flow into the annulus exterior tubing 402. The lighter phase oil will migrate towards the center of the cyclone to emerge as oil-rich stream 412 flowing from outlet 510 to drilling bit 404.

FIG. 6 illustrates detail of another example fluid separator 600 that in some instances could be used as fluid separator 406 of FIG. 4. Separator 600 includes a helical vanes 602 above a chamber 604 within a housing 606. As drilling fluid 408 enters the separator, spin is imparted by helical vanes 602. The denser phase (water) is forced to the walls of the separator to exit as water-rich stream 410. The lighter oil phase remains in the center portion of the chamber to exit as where it leaves separately as oil-rich stream 412. In some instances, separator 600 may be a powered unit in which helical vanes 602 are rotated by an electrical or hydraulicly driven motor.

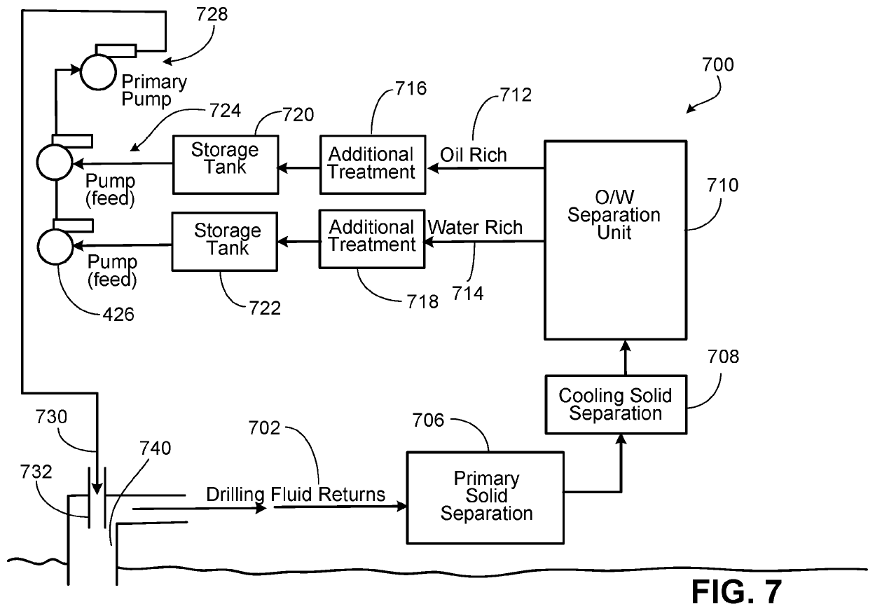

In using a downhole separator (of, for example, the types shown in FIGS. 5 and 6), the use of a drilling fluid having specified fluid characteristics (such as the degree of emulsion) can in some instances result in more efficient and effective separation of the water and oil phases. For example, in some instances, a “loose” (only partially emulsified) drilling fluid mixture can result in greater separation efficiency or other preferred performance of the separation as compared to the “tight” emulsion that is typical of many drilling fluids. A suitable drilling system 700 for creating and utilizing a loose-emulsion drilling system in some instances is shown in FIG. 7. Referring to FIG. 7, drilling fluid 702 flows at the surface from annulus 704. Solids such as cuttings and lost-circulation materials (LCM) can be separated from the drilling fluid at primary solid separator 706. From separator 706, drilling fluid 440 flows to cooling system 708, which in some instances can be (or can include) one or more coolers 230 of FIGS. 2A-2C. Cooling system 708 can utilize, for example, air-cooling, evaporative cooling, refrigeration cooling, or a combination of the three, and can be placed as shown receiving the steam from separator 706 but can be placed elsewhere in the system to cool combined or separated fluid streams. At oil-water separation system 710 fluid 702 is separated into two separate fluid trains (or streams): an oil-rich stream 712 and a water-rich stream 714. Separation system 710 can be, for example, a gravity separator, a centrifuge separator, and/or a cyclone separator. Oil-rich stream 712 and water-rich stream 714 can undergo further solids removal or other suitable treatment at treatment systems 716 and 718, respectively, after which they can flow into respective storage tanks 720 and 722. Feed pumps 724 and 726 pump the two streams to a common mixing system 728. Mixing system 728 can be configured to provide turbulent mixing of the two stream to create a loose emulsion (i.e., not fully emulsified) fluid mixture, and a pump to return the combined stream 730 to drilling string 732. The drilling fluid can flow down the drilling string in highly turbulent flow, and pass through the bit at high shear rates. The mechanical mixing effect of turbulent flow/high shear rates ensures sufficient mixing of the two fluids, without the need for emulsifying chemicals. Mixing system 728 can in some instances be configured such that the resulting loose emulsion has a desired target specified emulsion stability or other target characteristic or characteristics of the mixture. The target characteristic or characteristics of the mixture can in some instances be based on a desired target separation performance (such as separation efficiency or degree of separation) of the fluid separator or other operational parameter of the separator.

Alternatively, or additionally, use of a drilling string with multiple tubes 804, as shown in FIGS. 8A and 8B, can eliminate the need for a downhole separator. In particular, FIGS. 8A and 8B shows end cross-sectional views of two example tubings 802 constructed of multiple bundled tubes 804 within a protective sheath 806 that can be used as drilling string 200 (FIGS. 2A-2C). Such multiple tubes 804 enable flowing different fluids through different tubes 804, while maintaining the fluids separate. As discussed in more detail below, the tubes 804 can have different destinations within the drilling string, enabling different fluids to be directed to different locations without the need for separating intermixed fluids.

FIG. 8A shows five tubes 804 bundled around an umbilical cable 808, although fewer or more tubes could be provided and, in certain instances, the umbilical cable 808 can be omitted. The umbilical cable 808 can one or multiple electrical, fiber optic, hydraulic and/or other type of lines, and when multiple lines are provided within the umbilical cable 808, multiple different types of lines can be included. In certain instances, the umbilical cable 808 supplies electrical power and/or communications, such as control signals, data, and/or other communications. Thus, for example, in the context of a contactless drill bit (discussed above) the umbilical cable 808 can be coupled to the drill bit to provide power for the bit from a power source (e.g., generator, battery, capacitor bank and/or another power source) at an uphole and/or terranean surface location (e.g., the rig), communicate control signals with the bit and an uphole and/or terranean surface location, communicate sensor readings from sensors in the bit and/or other associated sensors with an uphole and/or terranean surface location, and/or otherwise provide power and/or communications. The umbilical cable 808 can additionally or alternatively provide power and/or communications to other components in the drilling string, including in the BHA. The umbilical cable 808 can be armored and/or electrically and thermally insulated, but by configuring the tubes 804 to reside around the cable 808, it need not be armored to withstand abrasion typical with a cable that would contact the wellbore wall or be exposed to abrasive drilling fluids. Furthermore, the umbilical cable 808 need not contribute to supporting the BHA, and the support to the BHA can be provided by the tubes 804.

FIG. 8B show three tubes 804 and an umbilical cable 808 bundled around a support cable 812. In certain instances, the support cable 812 is configured to support the full weight and other tension loads, such as during manipulating and running the tubing 802 in/out of the wellbore, without needing contribution from the remaining aspects of the tubing 802. In certain instances, the support cable 812 carries just a portion of the tension loads, and the remainder are carried by the other aspects of the tubing 802. In certain instances, the support cable 812 can be periodically anchored to the other aspects of the tubing 802, so as to support these other aspects. The support cable 812 can be stranded (as shown) or solid, and may be metallic (e.g. steel, titanium, aluminum and/or another metallic material) or non-metallic (e.g., carbon fibers, aramid fibers, fiberglass, e-glass, polymer fibers and/or another non-metallic material).

The tubes 804 can be bundled at the time of manufacture and brought to the drill site bundled together, or brought to the drill site as separate tubes 804 and bundled on site before and/or as the drilling string is run into the wellbore. The tubes 804 can be jointed tubing or coiled tubing. In the case of coiled tubing, bundling the tubes 804 at the drill site enables transporting the spools of the individual tubes 804 rather than spools of the bundled tubes 804. The spools of individual tubes 804 will be smaller diameter for a given length than a spool of the bundled tubes 804. Such smaller diameter spools are easier and less expensive to transport, particularly if transported by road, which has payload width and height restrictions.

In certain instances, the individual tubes 804 are steel, titanium, aluminum, polymer, fiber resin composite (e.g., carbon fiber, aramid fiber, fiberglass) and/or another material. Different individual tubes 804 in a bundle can be different materials. Some or all of the individual tubes 804 can be provided with an interior and/or exterior insulative coating (such as the coatings described above), and different tubes 804 can have different coatings. The bundled tubing 802 is shown including a protective tubing, as sheath 806. Not only can the sheath 806 maintain the individual tubes 804 together, the sheath 806 can be configured to endure the abrasion and impact of running the bundled tubing 802 through the wellbore and abrasive drilling fluids. Thus, the individual tubes 804 need not be steel or another material selected to withstand the abrasion and impact, or if the tubes 804 are covered in an insulative coating, the coating need not be designed to withstand the abrasion and impact. For example, the sheath 806 enables using polymer or fiber composite materials having properties selected for their thermal resistance over endurance to abrasion and impact. In certain instances, the sheath 806 is steel or aluminum, polymer (e.g., thermoplastic), composite or another material. In certain instances, the sheath 806 is 0.25″ steel or aluminum.

The voids between the sheath 806 and the individual tubes 804 (and umbilical cable 808, if provided) can be filled with an insulation 810. In certain instances, the insulation 810 can be a material selected in part to contribute to the buoyancy of the bundled tubing 802 in the fluids within the wellbore. In certain instances, the insulation 810 is selected to have a density lower than the density of the expected fluid in the annulus, which may be the drilling fluid or a combination of the drilling fluid and other fluids, e.g., the cooling fluid. In certain instances, the insulation is a polymer such as described above with respect to the tubing. Some examples include polyether ether ketone (PEEK), with a thermal conductivity of ˜0.25 W/mK at ambient temperature, Polytetrafluoroethylene (PTFE), with a thermal conductivity of ˜0.3 W/mK at ambient temperature and/or other polymers. In certain instances, the insulation can be omitted and the voids sealed and filled with a fluid (gas or liquid) selected in part to contribute to the buoyancy of the bundled tubing in the fluids within the wellbore. In certain instances, this fluid has a density lower than the density of the fluid in the wellbore. In certain instances, as shown in FIGS. 9A and 9B, the sheath 806 is a tube configured to handle fluid flow and the voids between the sheath 806 and the individual tubes 804 are used for flow. FIGS. 9A and 9B show the tubes 804 used for flow downhole. FIG. 9A shows the voids being used for flow downhole and FIG. 9B shows the voids used for flow uphole.

In other instances, the bundled tubes 804 can be provided without the sheath 806 and clamped together with ring clamps, bonded with adhesive, welded and/or otherwise maintained together.

In certain instances, the individual tubes 804 can all be the same size or one or more can be different sizes, selected based on the relative fluid flow rates through the tubes 804. Although any sizes of individual tubes 804 are within the concepts herein, in certain instances, the individual tubes 804 can be standard, commercially available tubing sizes (e.g., 1″, 1.25″, 1.5″, 1/75″, 2″, 2.375″, 2.625″, 2.875″ outer diameter). In certain examples, the bundled tubing 802 includes size 2″ outer diameter/1.8″ inner diameter individual tubes 804 around a 2″ umbilical cable 808. Such a configuration would have a flow area equivalent to a 4.4″ diameter single tubing, and provide sufficient hydraulic flow capacity for drilling an 8.5″ wellbore. The flow area would be greater than that of a standard 4″ coiled tubing, while being yet easier to transport to the drill site.

In certain instances, or more of the tubes 804 can be coupled to the drilling bit (e.g., bit 208) and used to flow a drilling fluid from the terranean surface and out through the bit into the wellbore being drilled, while one or more than one of the remaining tubes 804 can be open to the annulus surrounding the drilling string at one or more locations above the BHA (e.g., BHA 210) to flow a cooling fluid into the annulus around the drilling string above the BHA 210. The tubes 804 can be open to the annulus, for example by stopping short of the BHA 210 or by having one or more ports through a sidewall of the tube 804 above the BHA 210. Different of the tubes 804 can be open to the annulus at different locations along the drilling string to allow release of the cooling fluid at different locations, much like the multiple fluid diverters discussed above. Moreover, the multiple tubes 804 allow different fluids with different properties (e.g., different thermal properties such as heat capacity and conductivity, different density, different lubricity and/or other properties) to be directed to different locations, as well as at different flow rates, by flowing the different fluids through selected ones of the tubes 804.

Additionally or alternatively, one or more pair of the remaining tubes 804 can be coupled to one another so that the fluid is able to be circulated in a round trip (i.e., a closed system), from the terranean surface to a specified location along the drilling string through one tube 804 and back to the terranean surface through another tube 804. The tubes 804 configured to enable a round trip enable use of cooling fluids without introducing them into the annulus or otherwise into the wellbore. In certain instances, the closed system is desirable for fluids that are expensive, difficult to recover from the drilling fluid, incompatible with drilling fluid or the surrounding rock, or that the is otherwise a need or desire not to introduce the fluid into the wellbore. In one example, the closed system configuration enables use of a refrigerant cooled at the terranean surface (e.g., via cooler 230), and/or other fluids, as the cooling fluid.

Circulating temperatures that are too cold (below the minimum of the BHA operational temperature range) can result in failure of components designed for high bottom-hole temperatures. Specifically, for example, standard batteries which can be viable to −150° C., but high temperature batteries can be viable to 185° C. However, the higher temperature batteries can have an effective minimum temperature of, for example, 100° C. Similarly, mud motor efficiency and longevity (service life) can be dependent on the fit between the rotor and stator, and this fit cam be temperature-dependent (i.e., the motor configured for optimum operation at 125° C. can use different components and/or a different configuration as a similar motor optimized for 175° C. Thus, to reduce equipment failures and therefore the number of trips required to repair or replace BHA components, it can be desirable to maintain the drilling fluid at a relatively constant circulating temperature. While insulated tubing can enable cooler drilling fluid temperatures at the BHA than an upper maximum as the BHA progresses downhole during drilling, it can also result in BHA temperatures that are below a minimum operational BHA temperature at certain measured depths. Furthermore, such insulating material can be fragile and can suffer greater wear and tear than string or string segments without such an insulating layer (or with a thinner such layer). Such wear and tear can be worse in deviated, open-hole (as opposed to cased) wellbore sections and particularly in those portions of the drill string connected to our proximate the BHA because the torsional vibrations can be greater near the BHA, abrasion force can be increased in deviated wellbores, and the rock surface of the open hole can be more abrasive than the casing (for example steel casing). Therefore, in some instances it can be desirable for well system to be configured—and its operational plan to be developed/determined—such that, as the wellbore is drilled to the target measured depth, a temperature of the drilling fluid at the BHA neither substantially exceeds nor substantially falls below a target operational temperature range. Such temperatures or ranges can be rated operating temperatures or temperature ranges that are typically specified by the manufacturer and are above or below the rated operating temperatures. Thus, specified temperatures or temperature ranges can be established based on the operational life/temperature and/or performance/temperature relationships and the drilling operations configured to maintain the BHA within the specified target operating temperature or in temperature ranges. For example, for deviated wellbores, by carefully choosing where/how much insulation to use along the drill string, and adding more coated drill segments as drilling progresses, the circulating temperature can controlled to be relatively the same at the beginning of a horizontal section (for example, the heel of the wellbore) as at the end of the horizontal section (for example, the toe of the wellbore). Modifying the circulating flow rate (of cooled drilling fluid) and inlet fluid temperature (with mud coolers) can further refine the circulating temperature downhole, to maintain it within the operating range of BHA components. For deviated wellbores, the operational plan can by such that sections with an insulating layer (or are otherwise have high thermal resistance) remain mostly or entirely within the casing, and sections without an insulating layer or are otherwise less insulated used for the deviated/horizontal section. As drilling progresses, more coated drill segments is added to the string at the top, so the insulated portion, as a percent of the total string, increases as drilling progresses. In this way, coated sections are far away from the BHA, therefore reducing the exposure to severe torsional vibrations and abrasion, further reducing the needed frequency of trips required to repair or replace BHA, its components, and/or those portions of the drill string connected to or proximate the BHA.

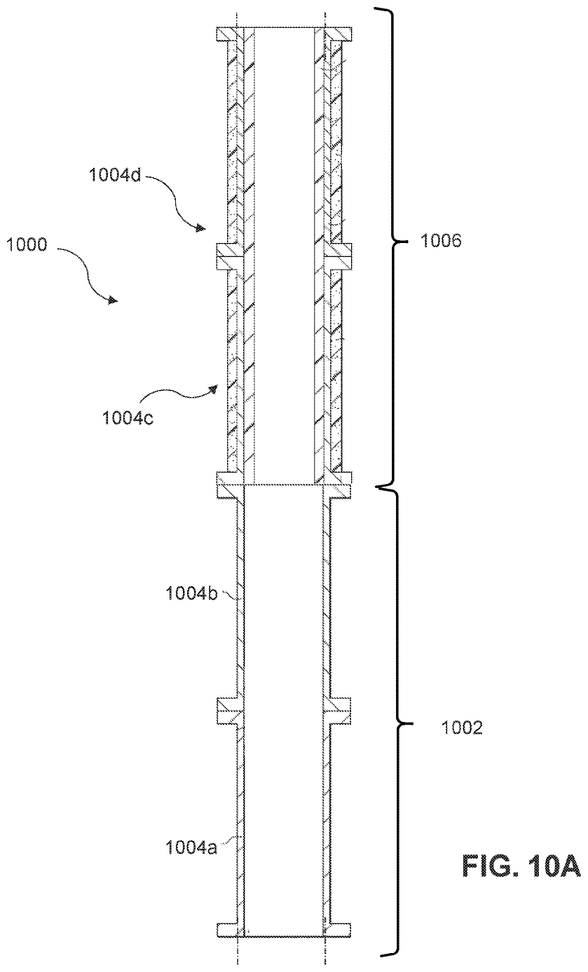

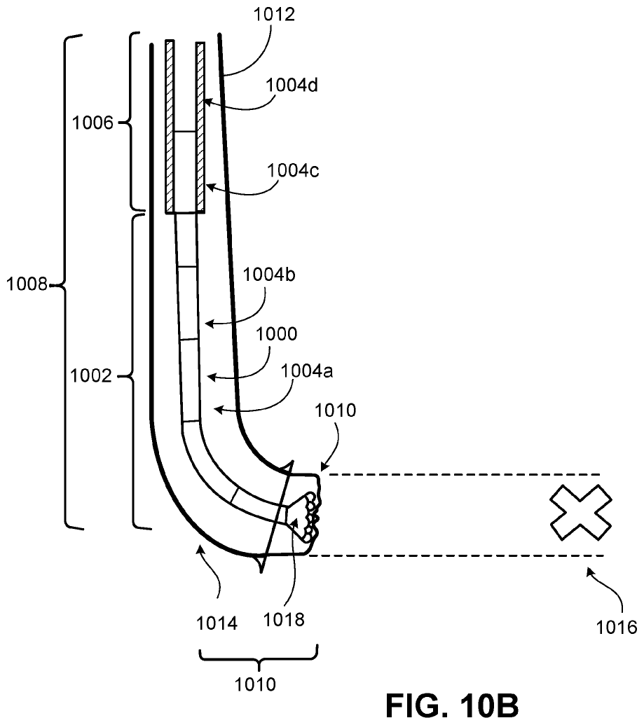

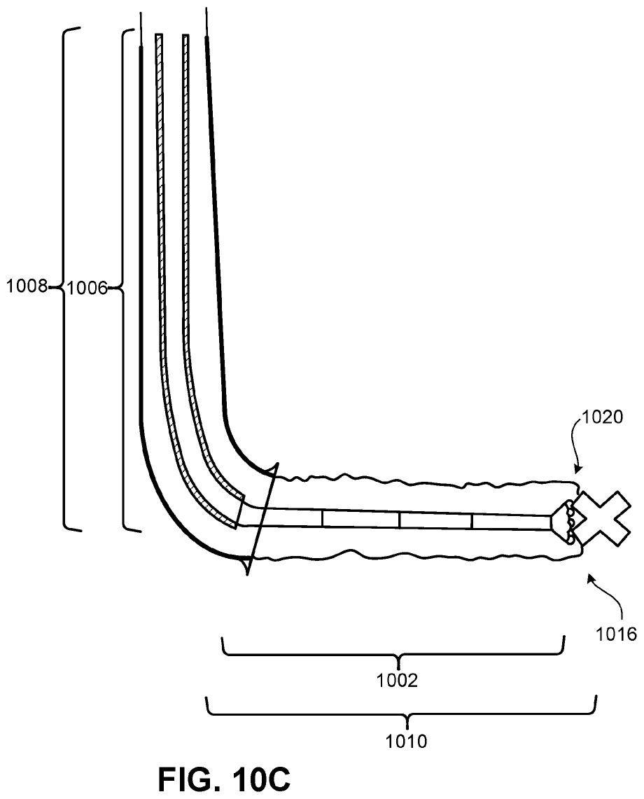

For example, in the instance illustrated in FIGS. 10A-10C, a drilling string 1000 (which can be, for example, drill string 200 of FIGS. 2A-2C) includes a downhole section 1002 comprising a first subset of tubular segments (including segments 1004a and 1004b in FIG. 10A) that are not coated with an insulating layer attached to an uphole section 1006 comprising a second subset of tubular segments (illustrated as 1004c and 1004d in FIG. 10A) having an insulating coating (such as that described in one or more of FIGS. 3A-3D), such that the uphole section 1006 has a greater thermal resistance (for example, at least 0.002 meters Kelvin per watt, or at least 0.008 meters Kelvin per watt, or at least 0.01 meters Kelvin per watt) than downhole section 1002. While sections 1002 and 1006 are for illustrative purposes shown with only two segments each, it will be understood that each subset may be made up of fewer or a greater number of segments (for example, only one segment (a singleton set) or one hundred or more segments in each subset). Referring to FIG. 10B, drilling string 1000 can be deployed to drill a surface wellbore 1008 (which can be, for example wellbores 120 or 130 of FIG. 1A or 1B) and a lateral wellbore 1010 (which can be, for example, lateral wellbores 150 of FIG. 1A or 1B). In the instance illustrated in FIGS. 10B and 10C, surface wellbore 1008 is cased with casing 1012 and the lateral wellbore 1010 is uncased. In the illustrated instance, the heel 1014 of lateral wellbore 1010 (and the shoe (downhole end) 1014) of casing 1012) is at a measured depth of approximately 13,000 feet, and the target measured depth 1016 is approximately 23,000 feet. Other instances can have different measured depths. The drill string 1000 is constructed in accordance with an operational plan such that a subset of less-insulated segments (for example, segments 1004a and 1004b of FIG. 10A) are added near the BHA 1018 to extend the lower subset 1006 of drill string 1000 from heel 1014 to toe 1020. However, some or all of the segments added to construct the upper subset 1006 are more highly insulated segments (for example, segments 1004c and 1004d of FIG. 10A), thus forming a length of insulated drill pipe that, as shown in FIG. 10C, remains in the casing 1012 as the BHA 1018 reaches the target measured depth 1016, thus minimizing wear and tear on the coated segments while maintaining BHA 1018 within both upper and lower operational temperature range. While in the illustrated instance lower subset 1002 is comprised entirely of segments with a thinner insulative coating than those of the upper portion (or no insulative coating and/or with abrasion-protection layers or coatings) such that they have a lower thermal resistance, at least some of lower subset 1002 can in other instances be comprised of segments having a higher thermal resistance than some of the segments of upper subset 1006. Likewise, while in the illustrated instance upper subset 1006 is comprised entirely of segments with higher thermal resistance than the lower section, some or all of upper subset 1006 can in other instances be comprised of segments of less thermal resistance than some of the segments of the lower subset. In some instances, instead of the drill string being comprised of segments of varying thermal resistance, all or a portion of the drill string can have an insulation coating that varies in thickness or that has other insulative and/or protective properties as it extends across several segments, or that extends across a continuous drill string (for example, an instance in which all or part of the drill string is comprised of coiled tubing).

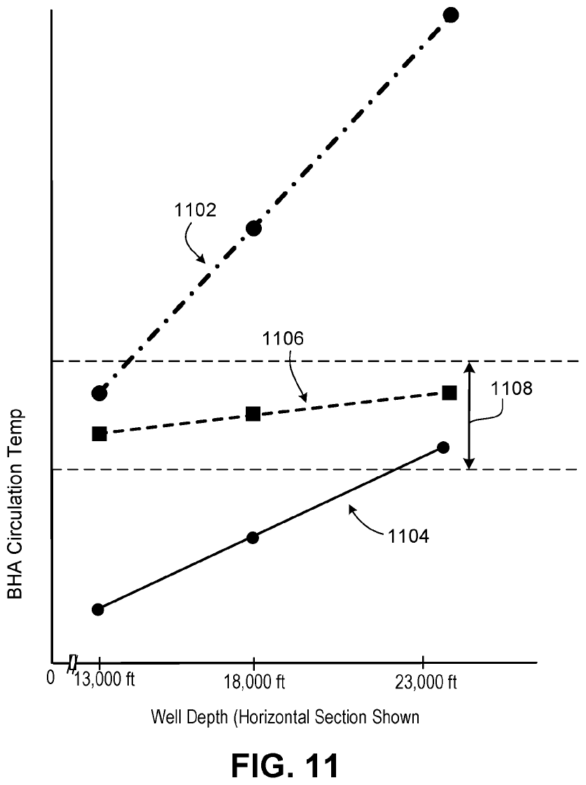

A representative temperature profile of the drilling operations shown in FIGS. 10B and 10C from heel 1014 to toe 1120 is shown in FIG. 11, comparing instances in which all, some, or none of the drill string is insulatively coated. Line 1102 illustrates BHA circulating temperatures as a function of depth if the wellbore is drilled using a drill string composed entirely of segments with a low thermal resistance. Line 1102 illustrates that, while temperatures using such a drill string begin within the operational temperature range of the BHA, temperatures quickly rise to exceed the maximum temperature as drilling continues towards the target depth. In contrast, line 1104 illustrates BHA circulating temperatures as a function of depth if the wellbore is drilled using a drill string composed entirely of highly insulated segments. Line 1104 shows that, while temperatures as the BHA approaches target depth do not exceed maximum operational temperature, temperatures as the lateral is initiated near the heel may fall below the minimum of the operational temperature range. Line 1106 illustrates BHA circulating temperatures as a function of depth if the wellbore is drilled using a drill string as shown in FIGS. 10C and 10B, having a lower portion (with a length approximately the same as that from the heel to the target depth) comprised of segments having a lower thermal resistance than the upper portion. Line 1106 illustrates that such a drill string configuration can result in BHA temperatures remaining within the operational range 1108 while drilling from the heel to the target depth. In other words, the temperature profile is “flattened” to remain within the operational range by the use of drill string constructed with such a specific sequence of segments with varying thermal resistance.

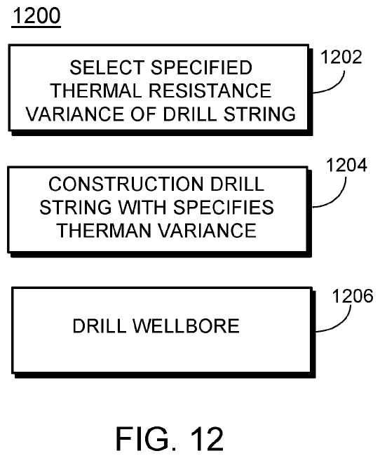

FIG. 12 is a process flow diagram of a method 1200 which can be implemented with the system described in reference to FIGS. 10A-10C and FIG. 11. The method begins at step 1202 in which a specified variance of thermal resistance of a drill string along its length is selected such that, as the wellbore is drilled by the drill string in the subterranean zone towards and then reaches the target measured depth, a temperature of the drilling fluid at a bottom-hole assembly to which the drilling fluid is conveyed by the drill string neither substantially exceeds nor substantially falls below a target operational temperature range. The selection can be developed using a numerical model (using, for example, finite element analysis) to model temperature, fluid flow, and other aspects of the wellbore along the length of the wellbore and drill string the drill string, considering different sequences of segments of different thermal resistance. The variance of thermal resistance of the drill string can be accomplished by, for example, lengthening the drill string by attaching, to an uphole end of the drill string as the wellbore is being drilled, specified tubular segments in a specified sequence having a second subset of the specified tubular segments attached to the drill string after a first subset of the specified tubular segments, as described above in reference to FIGS. 10A-10C. In some instances, each tubular segment of at least the second subset can have an insulative coating layer such that, when the wellbore reaches the target measured depth, a total thermal resistance of an uphole section of the drill string comprising the second subset is greater than a total thermal resistance of a downhole section of the drill string comprising the first subset. Proceeding to step 1204, the string is constructed so as to have the specified variance in thermal resistance. At step 1206, the wellbore is drilled with the drill string constructed in step 1204, having the specified variance of thermal resistance along its length. In some instances at least some of the activities within steps 1204 and 1206 can occur simultaneously, with the drill string being at least partially constructed during drilling by attaching, at the wellhead, the specified tubular segments in the specified sequence (with the individual segments having the same or different thermal resistance than some or all of the other segments), as described above in reference to FIGS. 10A-10C. In some instances, instead of (or in addition to) being constructed of discrete tubular segments, the variance in thermal resistance can be partially or fully accomplished by utilizing, for example, a drill string at least partially constructed coiled tubing having a varying thermal resistance along some or all of its length (for example, coiled tubing with an insulated coating, the width of which tapers along the length of the coiled tubing).

The term “uphole” as used herein means in the direction along a wellbore from its distal end towards the surface, and “downhole” as used herein means the direction along a wellbore from the surface towards its distal end. A downhole location means a location along a wellbore downhole of the surface.

While this disclosure contains many specific implementation details, these should not be construed as limitations on the subject matter or on what may be claimed, but rather as descriptions of features that may be specific to particular implementations. Certain features that are described in this disclosure in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Nevertheless, it will be understood that various modifications, substitutions, and alterations may be made. While operations are depicted in the drawings or claims in a particular order, this should not be understood as requiring that such operations be performed in the particular order shown or in sequential order, or that all illustrated operations be performed (some operations may be considered optional), to achieve desirable results. Accordingly, the previously described example implementations do not define or constrain this disclosure.

1. A method, comprising:
drilling, with a drill bit of a drilling string, a wellbore in a subterranean zone, the drilling string comprising tubing and a fluid separator uphole of the drill bit; and
while drilling:
flowing a drilling fluid through an interior of the drilling string and through the fluid separator, the fluid separator separating, from the drilling fluid, a fluid stream having a higher water-to-oil ratio than a remainder of the drilling fluid; and
diverting, uphole of the drill bit, the fluid stream from the fluid separator to an annulus around the exterior of the drilling string based on a specified temperature of a drilling string component while the remainder of the drilling fluid flows from the fluid separator to the drill bit.

2. The method of claim 1, wherein the drilling string component uphole of the separator is the tubing.

3. The method of claim 2, wherein the tubing comprises coiled tubing.

4. The method of claim 3, wherein the coiled tubing comprises a polymer tubing.

5. The method of claim 2, wherein the tubing comprises insulated drill pipe.

6. The method of claim 1, wherein the drilling fluid comprises an oil-water emulsion.

7. The method of claim 1, further comprising
receiving, at a terranean surface, a return flow from the annulus, the return flow comprising a mixture of the fluid stream and the remainder;
separating, at the terranean surface, the mixture into a water-rich surface stream and an oil-rich surface stream;
mixing, at the terranean surface, the water-rich surface stream and the oil-rich surface stream to form a mixture based on a target separation performance of the fluid separator; and
flowing the loose-emulsion mixture into the drilling string.

8. The method of claim 1, wherein the specified temperature is an operational temperature range.

9. The method of claim 1, further comprising diverting, by a diverter uphole of the separator, a portion of the drilling fluid from the drilling string into the annulus.

10. The method of claim 1, wherein the drill bit comprises a contactless drilling bit.

11. A system, comprising:
a drilling string comprising:
a tubing;
a drill bit; and
a fluid separator positioned in the drilling string to be uphole of the drill bit, where the fluid separator is configured to separate, from a drilling fluid flowed through an interior of the drilling string, a fluid stream comprising a higher water to oil ratio than the drilling fluid and where the drilling string is configured to divert the fluid stream to an annulus around the exterior of the drilling string based on a specified temperature of a drilling string component while a remainder of the drilling fluid flows from the fluid separator to the drill bit.

12. The system of claim 11, wherein the drilling string component uphole of the separator is the tubing.

13. The system of claim 12, wherein the tubing comprises coiled tubing.

14. The system claim 13, wherein the coiled tubing comprises a polymer coiled tubing.

15. The system of claim 11, wherein the tubing comprises insulated drill pipe.

16. The system of claim 11, wherein the drilling fluid comprises an oil-water emulsion.

17. The system of claim 11, wherein the system is further configured to:
receive at a terranean surface a return flow from the annulus, the return flow comprising a mixture of the fluid stream and the remainder;
separate the mixture into a water-rich surface stream and an oil-rich surface stream at the terranean surface;
mixing the water-rich surface stream and the oil-rich surface stream for form a mixture based on a target separation performance of the fluid separator; and
flow the loose-emulsion mixture into the drilling string.

18. The system of claim 11, wherein the specified temperature is an operational temperature range.

19. The system of claim 11, wherein the drilling string further comprises a diverter uphole of the separator, the diverter configured to divert a portion of the drilling fluid from the drilling string into the annulus.

20. The system of claim 11, wherein the drilling bit comprises a contactless drilling bit.
